(19) United States
(12) Patent Application Publication
(10) Pub. No.: US 2006/0150251 A1
(43) Pub. Date: Jul. 6, 2006

(54) Information recording medium, data processing method, and computer program

(75) Inventors: Yoshikazu Takashima, Tokyo (JP); Satoshi Kitani, Tokyo (JP); Jun Yonemitsu, Tokyo (JP); Katsumi Muramatsu, Tokyo (JP); Tomoyuki Asano, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/559,518

(22) PCT Filed: May 11, 2004
(86) PCT No.: PCT/JP04/06619

§ 371 Date: Dec. 6, 2005

(30) Foreign Application Priority Data
Jun. 9, 2003 (JP) 2003163723

(51) Int. Cl. H04N 7/16

(52) U.S. Cl. 726/26

(57) ABSTRACT

The present invention provides a configuration for preventing each entity code stored in information recording media from being leaked. Authoring studio code (ASC) and disc manufacturer code (DMC) are encrypted without failure and the encrypted codes are stored in information recording media. The data setting location in program map table (PMT) is controlled such that these entity codes will not overlap the seed area that provides key generating information, so that, if the packet storing the program map table storing authoring studio code (ASC) and disc manufacturer code (DMC) is set to an arbitrary position in a content packet sequence, these entity codes will not overlap the seed area that is non-encrypted data, thereby preventing these entity codes from being leaked outside.

### TECHNICAL FIELD

The present invention relates generally to an information recording medium, a data processing method, and a computer program. More particularly, the present invention relates to an information recording medium, a data processing method, and a computer program that prevent the unauthorized use of content based on the illegal copy of information recording media on which content is recorded.

### BACKGROUND ART

Recently, various kinds of audio data of music and so on, image data of movies and so on, game programs, application programs and software data (these data will hereafter generically referred to as content) are distributed through various kinds of information recording media such as CD (Compact Disc), DVD (Digital Versatile Disc), and MD (Mini Disc). These kinds of distributed content are reproduced for use on user's PC (Personal Computer), CD player, DVD player, MD player and other reproduction devices, and game machine, for example.

The distribution rights and other rights of many items of content such as music data and image data are generally owned by their producers or sellers. Therefore, it is a general practice in the distribution of content to impose certain restrictions on its use, namely, allow only authorized users to use content, thereby preventing the illegal copy of content for example from being practiced.

Recently, recording devices and recording media for recording information in a digital manner have been gaining popularity. These digital recording devices and recording media are capable of repeatedly recording and reproducing images and sounds for example without deterioration, thereby presenting a problem of the mass distribution of illegal copy content via the Internet and so-called pirated discs produced by replicating content onto CD-R and other recordable discs.

Recently developed DVD technology for example allows a huge amount of data of a whole movie for example to be recorded on a single disc as digital information. This situation makes it increasingly important to protect the copyright of content by preventing illegal copy.

The illegal copy of movie content is actually taking place. Therefore, with HD (High Definition) digital video cameras and HD digital video disc recorders expected to soon become reality in the consumer market, it is easily conceivable that leaving the above-mentioned problem unsolved would seriously damage the benefit of copyright holders.

Cases of illegal copy of content include the following for example:

<1. Videotaping and Theft at Movie Theater and Theft From Content Owner>

It is practiced that a newly released film movie being play in a movie theater is videotaped with a digital video camera and the video-taped movie is used as the source of DVD-video which is a ROM. It is also practiced to convert a movie film for movie theater by the telecine process into base-band video signal which is used as a source to manufacture pirated DVD-video ROMs without paying the price of the movie film and without the permission of the copyright holder.

In another case, the content obtained by recording a movie film owned by a content owner onto a HDD by the telecine process without permission of the owner. The recorded content is brought to DVD manufacturing facilities to produce DVD-video ROMs.

<2. Theft From Authoring Studio>

In the process of authoring which is ordered by a content owner, content may be stolen. The stolen content is brought to DVD manufacturing facilities to produce DVD-video ROMs.

<3. Replication From Authorized DVD-video (By Use of Code-breaking Technique)>

DVD players use CSS (Content Scramble System) for example as a technique for preventing unauthorized content use. In CSS, video data and audio data are recorded as encrypted on a DVD-ROM (Read Only Memory) and the decryption key for these encrypted data is given to each licensed DVD player. The license is granted to each DVD player that is designed to comply with a predetermined operation standard against illegal copy and so on. Therefore, each licensed DVD player can decrypt the encrypted data recorded on a DVD-ROM by use of the granted decryption key to reproduce images and sounds from the DVD-ROM.

On the other hand, unlicensed DVD players have no key for decrypting encrypted data and therefore cannot decrypt the encrypted data recorded to a DVD-ROM. Thus, in the CSS configuration, the DVD players not satisfying the conditions required at licensing cannot record digital data and reproduce DVD-ROMS, thereby preventing illegal copy from practicing.

However, DeCSS software for breaking CSS encryption has recently been spreading through the Internet. Anyone can easily get this software, break the encryption of content, and write the decrypted content to recordable DVDs in the form of plaintext. Therefore, it is apprehended that the encryption applied to digital video discs is broken and the content of these discs is brought to DVD manufacturing facilities to produce DVD-video ROMs.

<4. Replication From Authorized DVD-video (Use of Analog Output)>

Because personal computers (hereafter appropriately referred to as PCs) are not content-dedicated devices, they have no liability to respond to CGMS-A (Copy Generation Management System-Analog) and macrovision signals for example which are recorded to each content storage medium as copy control information. Therefore, copy control is not effectively imposed on personal computers, thereby making it practicable for personal computers to input the output from a DVD-video player into the video capture broad incorporated in each personal computer, thereby copying the video data to the personal computer's HDD (Hard Disc Drive). The video data recorded to the HDD is ready to be written to recordable DVDs any time in the state of plaintext. It is also practicable to bring the content thus obtained to DVD manufacturing facilities to produce DVD-video ROMs.

If the recording media which illegally copied are distributed on the market, the benefits of the copyright holders of various content items such as music and movies or the benefits of authorized dealers thereof would be seriously damaged.

It should be noted that, for a technique of preventing the unauthorized use of content, the applicant hereof proposed encryption processing techniques in which different keys are applied to the data blocks of content to be stored in a recording medium, which are disclosed in patent document 1 (Japanese Patent Laid-open No. 2001-351324) and patent document 2 (Japanese Patent Laid-open No. 2002-236622) for example. To be more specific, a seed is set as the key generation information for each data block and the seed set to each block is applied to the generation of cryptographic key to make complicated the content encryption conventionally practiced with only a single key, thereby enhancing the difficulty of breaking cryptographic algorithms.

However, in the process of manufacturing and marketing the information recording media such as content-recorded CDs and DVDs, content or the key information and so on associated with the encryption of content is distributed among various external business entities.

Problems here are that, in the current situation, no proper configuration has been realized in which the content management and key information management in the manufacture and distribution of content-recorded information recording media are executed in a centralized and effect manner, thereby making it difficult to trace the route of the distribution of illegal copy media. Especially, it is difficult to distinguish the media coming into the market as a result of the theft by content authors or disc manufacturers themselves from the authorized products, thereby making the problem more serious.

### DISCLOSURE OF INVENTION

It is therefore an object of the present invention to provide an information recording medium, a data processing method, an a computer program which, in a configuration in which content recorded to various information recording media such as DVD and CD is used on reproduction devices and information processing devices such as personal computers, can check whether the content-recorded information recording media are in the authorized manufacturing and sale routes consisting of authorized entities managed by a trusted center, ensure the copyright protection of content by enabling its reproduction on the basis of the result of this check, and realize the prevention of the leakage of the identification information of each entity recorded to each information recording medium.

In carrying out the invention and according to one aspect thereof, there is provided an information recording medium storing encrypted content, the information recording medium having a configuration in which content and an entity code set for each entity in a manufacturing route of the information recording medium and data included in a certain encryption processing unit is encrypted by a key generated on the basis of a seed providing encryption processing key generating information set for each the encryption processing unit and the entity code is stored in an encrypted area which is encrypted by the key generated on the basis of the seed, the encrypted area not overlapping an area to which the seed is set.

In the above-mentioned information recording medium according to the invention, the encryption processing unit is set as a collective data area of a plurality of packets and the seed is set as data having the predetermined number of bits from start data of a start packet of the encryption processing unit and the entity code is stored as a payload of each of the plurality of packets and stored in a data area not overlapping an area of bits constituting the seed.

In the above-mentioned information recording medium according to the invention, the entity code is stored in a program map table (PMT) specified by the MPEG standard and the entity code provides data constituting a start packet of a plurality of divided packets storing the program map table (PMT) in a program information area of the program map table (PMT).

In the above-mentioned information recording medium according to the invention, the start packet of the plurality of divided packets is a transport stream packet having a payload of 183 bytes and the entity code is stored as data within 183 bytes from start data of the program map table (PMT) in the program information area of the program map table (PMT).

In the above-mentioned information recording medium according to the invention, the entity code is stored in a program map table (PMT) specified by the MPEG standard, the program map table (PMT) is stored as a payload of each of a plurality of transport stream packets in a divided manner, and each of the plurality of transport stream packet is attached with timestamp information to be stored in the information recording medium as a source packet in a distributed manner.

In the above-mentioned information recording medium according to the invention, the information recording medium includes a first seed, which is key generating information set for each the encryption processing unit, an encrypted second seed, which is key generating information encrypted on the basis of a first block key Kb1 generated by the first seed, and encrypted content and an encrypted entity code encrypted on the basis of a second block key Kb2 generated on the basis of the second seed.

In the above-mentioned recording medium according to the invention, the entity code includes an authoring studio code (ASC) and a disc manufacturer code (DMC).

In carrying out the invention and according to a second aspect thereof, there is provided a data processing method for generating data to be written to an information recording medium, including: an entity code setting step in which a position at which an entity code set for an entity in a manufacturing route of the information recording medium is set is controlled to set the entity code in a control information table; a table information stored packet generating step in which a plurality of packets in which the control information table is stored in a divided manner are generated; a step in which the plurality of table information stored packets are arranged in a content stored packet sequence in a distributed manner; and a step in which data included in a certain encryption processing unit is encrypted by use of a key generated on the basis of a seed which is encryption processing key generating information set for each the encryption processing unit; wherein the entity code setting step includes a step in which control is executed such that the entity code is included in an encrypted area encrypted by a key generated on the basis of the seed without overlapping an area to which the seed is set.

In the above-mentioned data processing method, the encryption processing unit is a collective data area of a plurality of packets, the seed is data having the predetermined number of bits from start data of a start packet of the encryption processing unit, and the entity code setting step includes a step in which the entity code is set to a data area which does not overlap an area of bits constituting the seed.

In the above-mentioned data processing method, in the entity code setting step, the entity code is set in a program information area of the program map table (PMT) specified by the MPEG standard and to a position of data constituting a start packet of a plurality of divided packets storing the program map table (PMT).

In the above-mentioned data processing method, the start packet of the plurality of divided packets is a transport stream packet having a payload of 183 bytes and, in the entity code setting step, the entity code is set as data the program information area of the program map table (PMT) and within 183 bytes from start data of the program map table (PMT).

In carrying out the invention and according to a third aspect thereof, there is provided a computer program for executing the processing of generating data to be written to an information recording medium, including: an entity code setting step in which a position at which an entity code set for an entity in a manufacturing route of the information recording medium is set is controlled to set the entity code in a control information table; a table information stored packet generating step in which a plurality of packets in which the control information table is stored in a divided manner are generated; a step in which the plurality of table information stored packets are arranged in a content stored packet sequence in a distributed manner; and a step in which data included in a certain encryption processing unit is encrypted by use of a key generated on the basis of a seed which is encryption processing key generating information set for each the encryption processing unit; wherein the entity code setting step includes a step in which control is executed such that the entity code is included in an encrypted area encrypted by a key generated on the basis of the seed without overlapping an area to which the seed is set.

According to the present invention, the entity codes such as authoring studio code (ASC) and the disc manufacturer code (DMC) can be encrypted without failure and stored in information recording media to prevent these entity codes from being leaked outside. Therefore, the novel configuration can prevent the manufacturing of the recording media in which stored an illegally obtained copy of content made by use of these entity codes that are illegally obtained by masquerading entities. To be more specific, the data setting locations in program map table (PMT) is controlled such that these entity codes will not overlap the seed area that provides key generating information, so that, if the packet storing the program map table storing authoring studio code (ASC) and disc manufacturer code (DMC) is set to an arbitrary position in a content packet sequence, these entity codes will not overlap the seed area that is non-encrypted data, thereby preventing these entity codes from being leaked outside.

Further, in the novel configuration, authoring studio code (ASC) and disc manufacturer code (DMC) are stored in each information recording medium along with encrypted content and the encrypted content can be reproduced only when the detection and matching of these entity codes are successfully executed, so that any attempt to reproduce content stored in any recording medium having the illegally obtained codes or any information recording medium that stores none of these entity codes is defeated, thereby allowing the reproduction of only the content stored in the recording media that have been manufactured on the basis of authorized manufacturing routes. In case the manufacturing and distributing of unauthorized replications should happen, this configuration also allows the easy tracing of information leakage routes by the detection of authoring studio code (ASC) and disc manufacturer code (DMC).

Still further, in the novel configuration, the code information of each entity is stored in each information recording medium, so that only the content authoring entity and information recording medium manufacturing entity that are managed by the trusted center are allowed to author content and manufacture the information recording media storing the authored content, thereby making it practicable, in case of the illegal replication of the information recording media, to trace information leakage routes on the basis of the detection of these entity codes.

It should be noted that the computer program according to the invention is a computer program that can be provided to any general-purpose computer system that can execute various program codes, in the computer-readable forms of recording media such as CD, DVD, MO for example and communication media such as networks. The provision of the program in computer-readable forms realizes the processing corresponding to the program on the computer systems.

Many other features, advantages, and additional objects of the present invention will become manifest to those versed in the art upon making reference to the detailed description which follows and the accompanying sheet of drawings. It should be noted that term “system” as used herein denotes a logical aggregation of plural devices and is not restricted to a configuration in which all its components are accommodated in a single housing.

### BRIEF DESCRIPTION OF DRAWINGS

FIG. 1 is a schematic diagram illustrating a data configuration in which data is stored in an information recording medium;

FIG. 2 is a schematic diagram illustrating routes of the management of data which is stored in an information recording medium and the manufacture thereof;

FIG. 3 shows a tree structure which is applied to the encryption and distribution of various keys and data;

FIG. 4 shows exemplary enabling key blocks (EKBs) for use in the distribution of various key and data;

FIG. 5 shows a schematic diagram illustrating exemplary distribution and decryption processing by use of the enabling key block (EKB) of content key;

FIG. 6 shows a configuration in which data is stored in an information recording medium;

FIG. 7 is a schematic diagram illustrating a program map table PMT which includes an authoring studio code (ASC) and a disc manufacturer code (DMC) stored in an information recording medium;

FIG. 8 is a block diagram illustrating an exemplary configuration of an information processing device;

FIG. 9 is a block diagram illustrating content decryption and reproduction control processing which is executed in the information processing device;

FIG. 10 is a block diagram illustrating the content decryption processing which is executed in the information processing device;

FIG. 11 shows examples of disc-unique key generation processing;

FIG. 12 shows a sequence of decrypting encrypted data;

FIG. 13 is a block diagram illustrating content reproduction control processing;

FIG. 14 is a flowchart indicative of procedures of content decryption processing and reproduction control processing;

FIG. 15 is a flowchart indicative of the procedures of content decryption processing and reproduction control processing;

FIG. 16 shows examples of seed information storage configurations;

FIG. 17 is a block diagram illustrating data storage processing and encryption processing which are executed on an information recording medium for each entity;

FIG. 18 shows an exemplary configuration of program map table PMT data including authoring studio code (ASC) and disc manufacturer code (DMC);

FIG. 19 shows an exemplary configuration of setting seed 2 for each AU as encryption processing unit;

FIG. 20 shows positions at which authoring studio code (ASC) and disc manufacturer code (DMC) are stored;

FIG. 21 shows positions at which authoring studio code (ASC) and disc manufacturer code (DMC) are stored;

FIG. 22 is a block diagram illustrating encryption processing which is executed by content authoring entity;

FIG. 23 is a block diagram illustrating encryption processing which is executed by information recording medium manufacturing entity;

FIG. 24 is a block diagram illustrating data storage processing and encryption processing which are executed on an information recording medium for each entity in a processing example with no disc ID used;

FIG. 25 is a schematic diagram illustrating a configuration of data which is stored on an information recording medium in a processing example with no disc ID used;

FIG. 26 is a block diagram illustrating content decryption processing which is executed in an information processing device in a processing example with no disc ID used; and

FIG. 27 is a block diagram illustrating an exemplary configuration of an information processing device which is applied to a user device and each entity.

### BEST MODE FOR CARRYING OUT THE INVENTION

The following details the information recording medium, data processing method, and computer program according to the invention.

[Overview of Data Recording Configuration on Recording Medium and Manufacturing Process]

First, a data configuration in which data is stored on an information recording medium according to the invention and a process of manufacturing this information recording medium will be overviewed. Encrypted data stored on the information recording medium is read, decrypted, and reproduced on data recording/reproducing devices or PCs (Personal Computers).

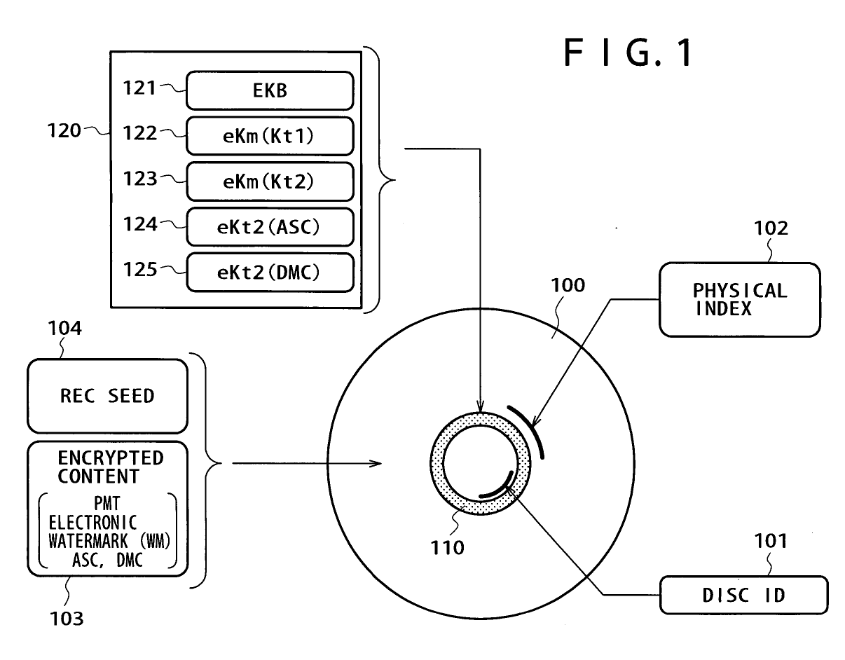

The following describes data which is stored on the information recording medium according to the invention, with reference to FIG. 1. It should be noted that the information recording media according to the invention include various types of information recording media such as optical, magnetic, semiconductor, and flash memories and are not restricted to disc-shaped memories.

As shown in FIG. 1, an information recording medium 100 stores a disc ID 101, a physical index 102, encrypted content 103, a record seed (REC SEED) 104, and cryptographic key information 120. The cryptographic key information 120 is stored in a lead-in area 110 which can be read on the basis of a special program, this area being different from the content storage area of the information recording medium 100.

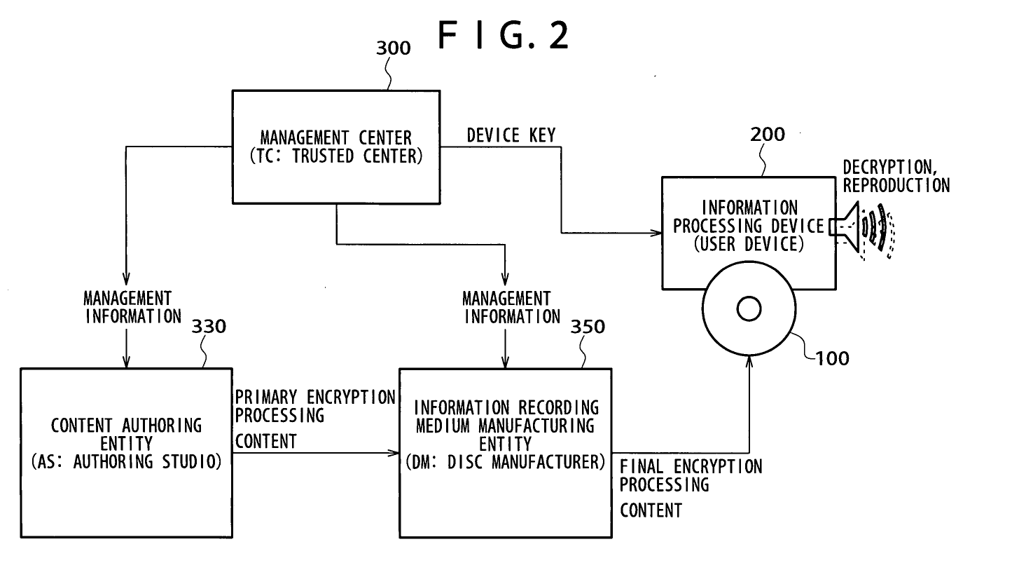

The cryptographic key information 120 includes various key information necessary for the decryption and reproduction of the encrypted content 103 stored on the information recording medium 100. The following describes the overview of the information which is recorded to information recording media and a route of manufacturing these information recording media with reference to FIGS. 1 and 2.

As shown in FIG. 2, content to be stored on information recording media is authored by a content authoring entity (AS: Authoring Studio) 330. The recording medium on which the authored content is recorded is replicated in bulk at an information recording medium manufacturing entity (DM: Disc Manufacturer) 350 in the form of CD or DVD, the resultant information recording medium 100 being provided to users. The information recording medium 100 is reproduced on an information processing device 200 of each user.

The total management over the disc manufacturing, sale, and use of the information recording medium 100 is executed by a management center (TC: Trusted Center) 300. The management center (TC: Trusted Center) 300 provides various kinds of information to the content authoring entity (AS: Authoring Studio) 330 and the information recording medium manufacturing entity (DM: Disc Manufacturer) 350. On the basis of the management information supplied by the management center (TC: Trusted Center) 300, the content authoring entity (AS: Authoring Studio) 330 and the information recording medium manufacturing entity (DM: Disc Manufacturer) 350 execute the authoring, encryption, key information generation, and storage of content. Also, the management center (TC: Trusted Center) 300 manages and provides a device key to be stored in the user's information processing device. The details of these pieces of information will be described later.

The cryptographic key information 120 shown in FIG. 1 includes various kinds of key information necessary for the decryption and reproduction of the encrypted content 103 stored in the information recording medium 100. The cryptographic key information 120 is generated by the trusted center 300 and is provided to the information recording medium manufacturing entity (DM: Disc Manufacturer) 350. The information recording medium manufacturing entity (DM: Disc Manufacturer) 350 stores the cryptographic key information 120 supplied by the trusted center 300 into the lead-in area 110 of the information recording medium 100.

The cryptographic key information 120 includes an EKB 121 as a cryptographic key block stored by encrypting a media key Km necessary for the reproduction of content, an encrypted first title key eKm(Kt1) 122 obtained by encrypting a first title key (Kt1) set in correspondence with content or medium by a media key Km, an encrypted second title key eKm(Kt2) 123 obtained by encrypting a second title key (Kt2) by the media key, an encrypted ASC:eKt2(ASC) 124 obtained by encrypting an authoring studio code (ASC) set in correspondence with a content authoring entity by a second title key (Kt2), and an encrypted DMC:eKt2(DMC) 125 obtained by encrypting a disc manufacturer code (DMC): Disc Manufacturer Code) by the second title key (Kt2).

It should be noted that the authoring studio code (ASC) and the disc manufacturer code (DMC) are identification information which is by the trusted center to the external business entities acknowledged to be authentic by the trusted center in the routes of manufacturing and marketing the information recording media recorded with content. In the present embodiment, examples will be described in which these codes are code data set as an authoring studio identifier and a disc manufacturer identifier respectively. For example, these codes may be set for each manufacturing unit (or lot) or order unit of recording media. Alternatively, these codes may be set for each piece of content to be recorded to recording media. It is also practicable to set these codes as those which include date information such as order date or manufacture date of recording media in which content is stored. The details of the storage forms of these code data will be described later.

The EKB 121 denotes an enabling key block which can get a media key necessary for content decryption only by the processing (or decryption) based on a device key stored in the information processing device of each user having a valid license key. The key information block enables the key acquisition based on the validity of the license granted to the user device (or the information processing device) by an information distribution method based on a so-called hierarchical tree structure, thereby preventing the acquisition of the key (or the media key) of the revoked user device. By changing the key information to be stored in EKB, the trusted center can generate an EKB that has a configuration in which encrypted content cannot be decrypted by the device key stored in a particular user device, namely the media key necessary for content decryption cannot be acquired.

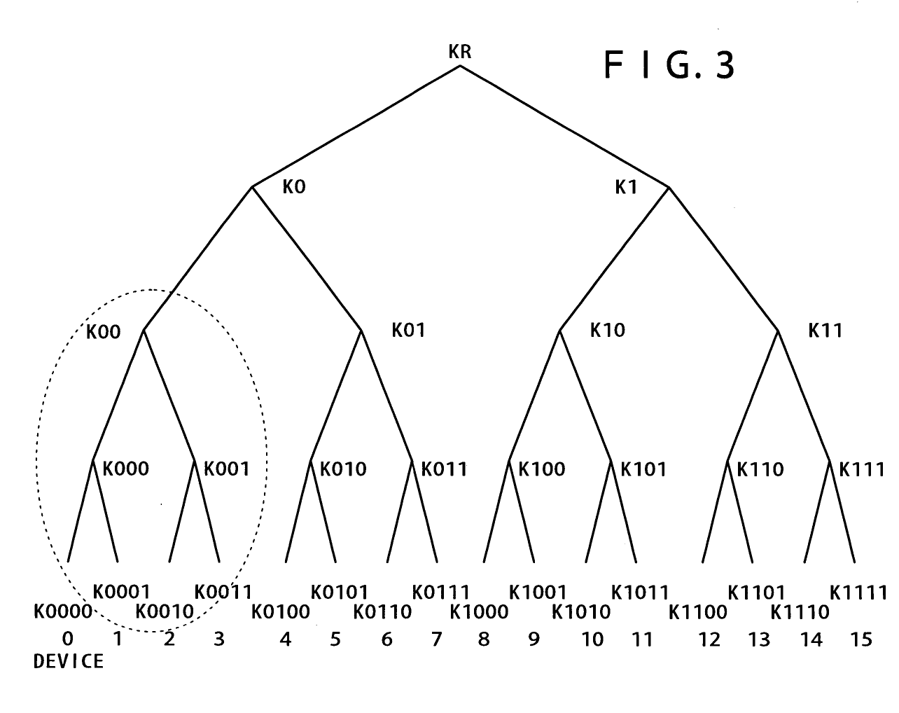

The following describes the processing of providing encrypted data such as cryptographic keys to which a hierarchical tree structure is applied, with reference to drawings. Numbers 0 through 15 shown at the bottom of FIG. 3 indicate user devices functioning as information processing devices on which content is used for example. Namely, the leaves of the hierarchical tree shown in FIG. 3 respectively correspond to the user devices.

Devices 0 through 15 each store, in its memory, keys (or node keys) allocated to its node starting with its leaf and ending with the root and a key set (device key (DNK: Device Node Key) composed of the leaf keys of each leaf). K0000 through K1111 indicated at the bottom of FIG. 3 are the leaf keys respectively allocated to the devices 0 through 15. The keys shown between a KR (root key) at top and those shown on the second node from bottom, KR through K111 for example, are node keys.

In the tree structure shown in FIG. 3, device 0 for example has leaf key K0000 and node keys K000, K00, K0, and KR, as its device keys. Device 5 for example has K0101, K010, K01, K0, and KR. Device 15 for has K1111, K111, K11, K1, and KR. It should be noted that the tree shown in FIG. 3 has only 16 devices, 0 through 15, and four layers in a symmetrical manner; obviously, the tree can be more devices and the layers inside the tree may be arranged in an asymmetrical manner.

The devices included in the tree structure shown in FIG. 3 include various types of devices which use various media, such as the DVD, the CD, the MD, the flash memory, and so on adapted to be used as incorporated in the device or removable therefrom. Moreover, various application services may exist together in these devices. The layered tree structure of the content or key distribution configuration as shown in FIG. 3 is applied on the basis of such configuration in which various devices and various applications exist together.

In a system in which these various kinds of devices and applications exist together, a portion enclosed by a dashed line for example shown in FIG. 3, namely devices 0, 1, 2, and 3, are set as one group that uses a same recording medium. For example, such processing is executed on the devices in this group enclosed by a dashed line as the provision of common content from a provider by encrypting and transmitting the content via a network or in an information recording medium like CD, the transmission of a content key which can be commonly used by all of these devices, and the output of encrypted content fee payment data from each of these devices to the provider or an accounting settlement organization. The entities such as content servers, license servers, and shop servers which execute data transmission/reception with devices can execute the processing of transmitting data in a lump to the portion enclosed by dashed line shown in FIG. 3, namely devices 0, 1, 2, and 3, as one group. There are two or more groups of this kind in the tree shown in FIG. 3.

It should be noted that the node keys and the leaf keys may be collectively managed by one managing system having trusted center capabilities or may be managed by a configuration in which the management is executed on a group basis by message data distribution means such as a provider or an accounting settlement organization which executes various data transmission/reception operations with each group. These node keys and leaf keys are renewed if key leakage occurs for example. This renewal processing may be executed by a management system, a provider, or an account settlement organization that has key management center capabilities.

As seen from FIG. 3, in the above-mentioned tree structure, three devices 0, 1, 2, and 3 included in one group each have a device key (DNK: Device Node Key) which includes common keys K00, K0, and KR as the device key (DNK: Device Node Key). Use of this node key sharing configuration allows the provision of the common keys only to devices 0, 1, 2, and 3. For example, the commonly owned node key K00 becomes an owned key common to devices 0, 1, 2, and 3. Also, the distribution of value Enc(K00, Knew) obtained by encrypting new key Knew by node key K00 to devices 0, 1, 2, and 3 via a network or in a recording medium allows only devices 0, 1, 2, and 3 to get new key Knew by decrypting encryption Enc(K00, Knew) by use of common node key K00 owned by each device. It should be noted that Enc(Ka, Kb) denotes the data obtained by encrypting Kb by Ka.

If the keys K0011, K001, K00, K0 and KR owned by device 3 were broken by a hacker for exposure at time t for example, it is subsequently necessary to disconnect device 3 from the system in order to protect the data which is transmitted/received in the system (the group of devices 0, 1, 2, and 3). To do so, it is required to renew node keys K001, K00, K0, and KR to new keys K(t)001, K(t)00, K(t)0, and K(t)R and transmit these new keys to devices 0, 1, and 2. K(t)aaa denotes the renewal key of generation t of key Kaaa.

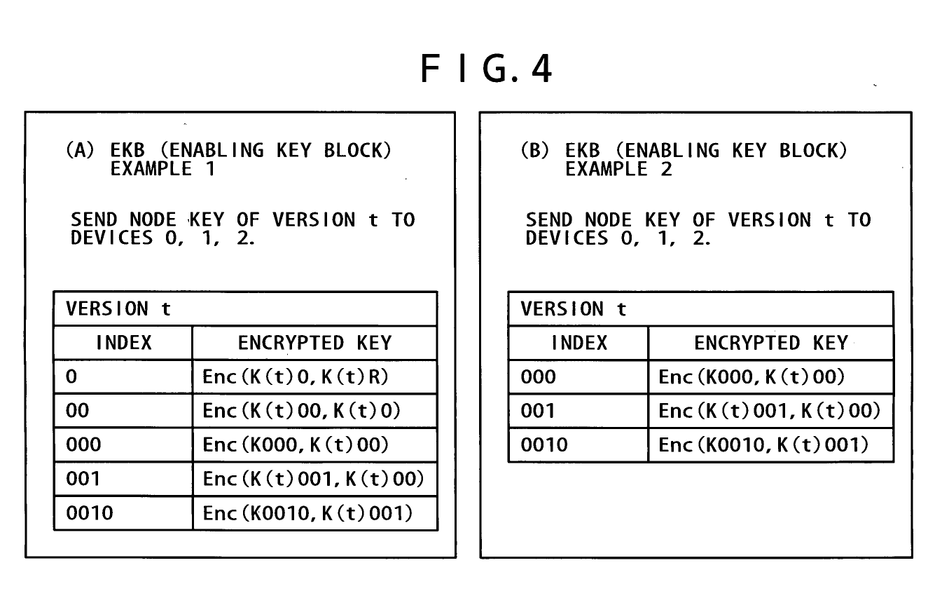

The following describes renewal key distribution processing. Key renewal processing is executed by supplying a table composed of block data called an enabling key block (EKB) shown in FIG. 4(A) for example to devices 0, 1, and 2 via a network or in a recording medium. It should be noted that an enabling key block (EKB) is composed based on an encrypted key for distributing the renewal keys to the devices corresponding to the leaves in a tree structure as shown in FIG. 4. An enabling key block (EKB) is also referred to as a key renewal block (KRB).

The enabling key block (EKB) shown in FIG. 4(A) is configured as block data which has a data configuration in which can be renewed only by the device of which node keys must be renewed. The example shown in FIG. 4 shows the block data formed for the purpose of distributing the renewal node keys of generation t in devices 0, 1, and 2 in the tree structure shown in FIG. 3. As seen from FIG. 3, devices 0 and 1 require K(t)00, K(t)0, and K(t)R as renewal node keys and device 2 requires K(t)001, K(t)00, K(t)0, and K(t)R as renewal node keys.

As shown in the EKB of FIG. 4(A), the EKB includes a plurality of encrypted keys. The encrypted key shown at the bottom is Enc(K0010, K(t)001). This is the renewal node key K(t)001 encrypted by leaf key K0010 owned by device 2. Device 2 can decrypt this encrypted key by its own leaf key to get K(t)001. By use of K(t)001 obtained by decryption, the encrypted key Enc(K(t)001, K(t)00) on the second row from bottom shown in FIG. 4(A) can be decrypted to get renewal node key K(t)00. Subsequently, encrypted key Enc(K(t)00, K(t)0) on the second row from top shown in FIG. 4(A) is decrypted to get renewal node key K(t)0 and encrypted key Enc(K(t)0, K(t)R) on the top row shown in FIG. 4(A) are decrypted to get K(t)R.

On the other hand, with devices K0000 and K0001, node key K000 is not included in the keys to be renewed; the necessary nodes keys are K(t)00, K(t)0, and K(t)R. With devices K0000 and K0001, encrypted key Enc(K000, K(t)00) on the third row from top shown in FIG. 4(A) is decrypted to get K(t)00, encrypted key Enc(K(t)00, K(t)0) on the second row from top is decrypted to get renewal node key K(t)0, and encrypted key Enc(K(t)0, K(t)R) on the top row shown in FIG. 4(A) is decrypted to get K(t)R. Thus, devices 0, 1, and 2 can get renewal key K(t)R. It should be noted that the index shown in FIG. 4(A) indicates the absolute addresses of the node keys and leaf keys for use as decryption keys.

If the renewal of node keys K(t)0 and K(t)R on the upper row in the tree structure shown in FIG. 3 is unnecessary and the renewal of only node key K00 is necessary, then use of the enabling key block (EKB) shown in FIG. 4(B) allows the distribution of renewal node key K(t)00 to devices 0, 1, and 2.

The EKB shown in FIG. 4(B) can be used if a media key Km which can be obtained only in a particular group is distributed, for example. It is assumed for example that a media key Km which can be used only on devices 0, 1, 2, and 3 in the group enclosed by dashed line shown in FIG. 3 be distributed. At this time, data Enc(K(t)00, K(t)m) obtained by encrypting a new media key Km by use of K(t)00 obtained by renewing node key K00 common to devices 0, 1, 2, and 3 is distributed along with the EKB shown in FIG. 4 (B). This distribution allows the distribution of the data which cannot be decrypted by other devices as device 4 for example.

Namely, with devices 0, 1, and 2, decrypting the above-mentioned ciphertext by use of K(t)00 obtained by processing the EKB allows the acquisition of the key at time t, media key K(t)m to be applied to content encryption/decryption for example.

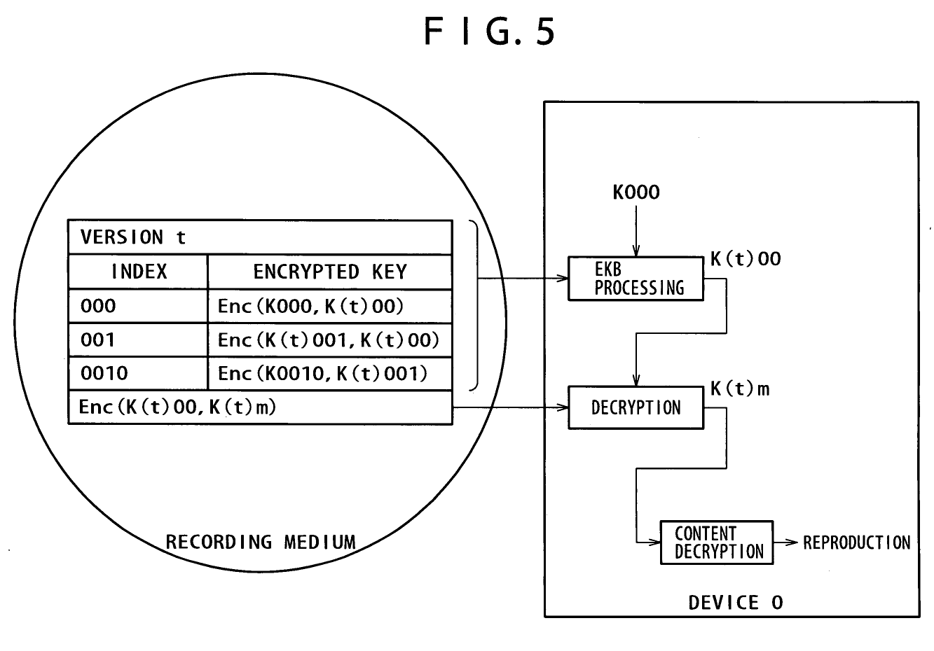

FIG. 5 shows an example of processing for obtaining the key at time t, media key K(t)m which is applied to content encryption/decryption for example. It is assumed that the EKB store data Enc(K(t)00, K(t)m) obtained by encrypting media key K(t)m by use of K(t)00, along with the data shown in FIG. 4 (B). In this example, device 0 is used.

As shown in FIG. 5, device 0 generates node key K(t)00 by the same EKB processing as described above, by use of the EKB at generation t stored in a recording medium and node key K000 stored in device 0 in advance. Further, by use of decrypted renewal key K(t)00, device 0 decrypts encrypted data Enc(K(t)00, K(t)m) to get renewal media key K(t)m.

Another example is possible in which only the devices may be obtained that does not require the renewal of node keys in a tree structure but requires only media key K(t)m at time t. In this case, a method shown below may be used.

It is assumed here that media key K(t)m be transmitted to only devices 0, 1, and 2 as with the example shown in FIG. 3. In this case, EKB is as follows:

Version: t

Index : Encrypted key

000: Enc(K000, K(t)m)

0010: Enc(K0010, K(t)m)

Devices 0 and 1 can use K000 and device 2 can use K0010 to decrypt one of ciphertexts of the above-mentioned EKB, thereby getting a content key. This configuration enhances the efficiency of a method of giving a content key to necessary devices although node key renewal cannot be executed (namely, this configuration reduces the size of EKB by reducing the number of ciphertexts included in EKB as well as the number of times encryption is executed at the trusted center and decryption is executed at each device).

The following describes the details of other data which is stored in the information recording medium 100 with reference to FIG. 1 again. The disc ID 101 an information recording medium ID which is an identifier unique to each information recording medium. The disc ID 101 is the management information which is generated by the trusted center 300 and passed to the information recording medium manufacturing entity 350, being different for each disc. For example, the trusted center 300 generates a seed (S) which is different for each disc and generates, for the number of discs allowed by the trusted center, data (S, Sig) attached with electronic signature (Sig) for verification of alteration, providing the generated data to the information recording medium manufacturing entity 350. The information recording medium manufacturing entity 350 stores the ID information (S, Sig) which is different for each disc into each information recording medium (or each disc).

In the information processing device of the user who executes content reproduction, the ID information (S, Sig) stored in an information recording medium (or a disc) is read. If the ID information is found by signature verification processing to be unaltered, then the procedure moves to content decryption processing. It should be noted that the signature may include the signature based on the public key cryptography or the signature based on the common key cryptography such as MAC. In the application of the signature based on the public key cryptography, the trusted center 300 executes signature generation based on private key and the information processing device of each user executes signature verification based on the public key of the trusted center 300. In the case of the common key method, a common signature key is shared between the trusted center and the user device to execute signature generation and verification processing. The processing to be executed by the information processing device of the user (or the user device) will be described later.

The physical index 102 which is stored in the information recording medium shown in FIG. 1 is generated by the information recording medium manufacturing entity 350 and stored in the information recording medium. The record seed (REC SEED) 104 is generated by the content authoring entity 330 and passed to the information recording medium manufacturing entity 350 to be stored in the information recording medium.

The encrypted content 103 stores a program map table PMT which includes authoring studio code (ASC) and disc manufacturer code (DMC). PMT which is the information including authoring studio code (ASC) and disc manufacturer code (DMC) and is embedded in content at the content authoring entity 330. In addition, the encrypted content 103 stores authoring studio code (ASC: Authoring Studio Code) as electronic watermark (WM: WaterMark) and disc manufacturer code (DMC). The embedding of these codes is executed at the trusted center 300. The detail sequence of the processing of embedding various data into the information recording medium will be described later.

The encrypted content which is stored in each information recording medium is configured as a transport stream (TS) as the encoded data specified by the MPEG-2 system for example. A transport stream can configure two or more programs in it and has ATS (Arrival TimeStamp) providing the information indicative of the timing of occurrence of each transport packet. This timestamp is determined at the time of encoding so that T-STD (Transport Stream System Target Decoder), a virtual decoder specified in the MPEG-2 system, is not failed and controls the occurrence timing by the ATS added to each transport packet at the time of stream reproduction to decrypt and reproduce the transport stream.

For example, in recording transport stream packets to a recording medium, the packets are recorded as source packets with the intervals therebetween closed up. Storing the occurrence timing of each transport packet in the recording medium along with the transport packets allows the control of the output timing of each packet at the time of its reproduction.

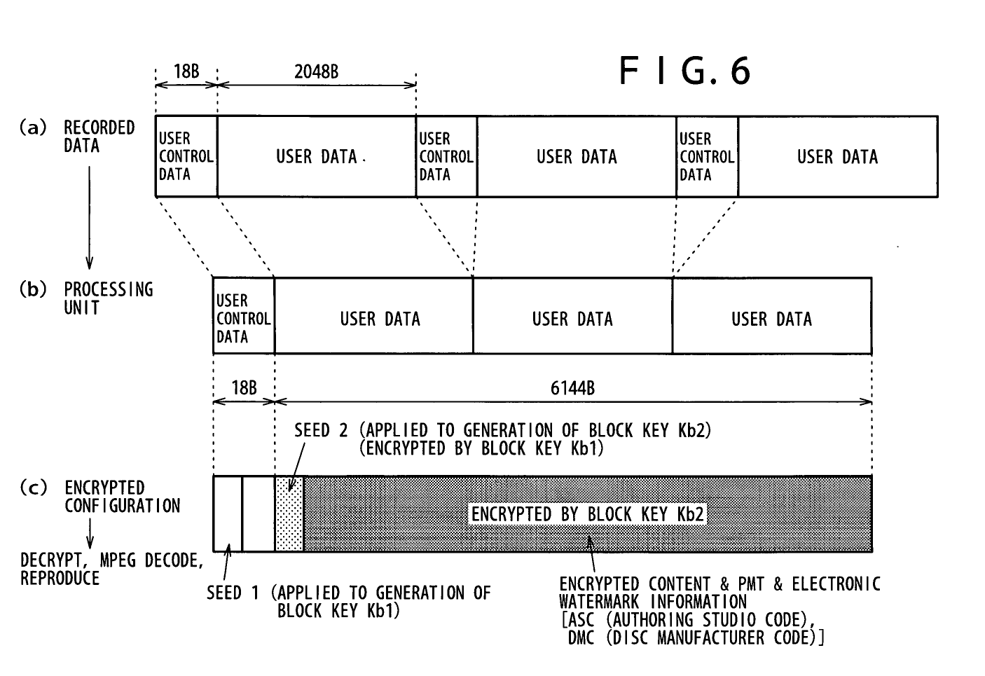

The overviews, the recording configuration of data stored in an information recording medium and the processing of recorded data decryption and reproduction, will be hereinafter described with reference to FIG. 6. The data stored in each information recording medium is encrypted data; therefore its reproduction requires its decryption. FIG. 6(a) shows a data recording configuration in which data is stored in an information recording medium. Control data (User Control Data) of 18 bytes and user data of 2048 bytes are configured as one sector data; for example, data equivalent to three sectors is specified as one unit of encryption processing. It should be noted that the byte count and processing unit described herein are nothing but examples; therefore, various other byte counts of control data and user data and the processing units may be set.

(b) shows a configuration of one unit (1 AU: Aligned Unit) in which encryption processing is executed. The information processing device which executes the reproduction of encrypted data stored in an information recording medium extracts one AU (Aligned Unit) which is a encryption processing unit on the basis of a flag in the control data.

One unit (1 AU) which is an encryption processing unit includes an area encrypted by block key Kb1 and an area encrypted by block key Kb2 as shown in (c) encrypted configuration. Alternatively this unit may include an area which is encrypted in a duplicate manner by use of block keys Kb1 and Kb2. Generating the block keys requires seed information which is key generating information. Seed information (seed 1) is key generating information for generating block key Kb1 and seed information (seed 2) is key generating information for generating block key Kb2. For these pieces of key generating information, 128-bit information or 64-bit information extracted, for each encryption processing unit (1 AU), from the stored information in the encryption processing unit, namely, the control information and a data sequence such as content in the user data area. The seed information storage mode and encryption mode shown in FIG. 6(c) are nothing but examples. Other exemplary configurations will be described later.

Decrypting the encrypted content stored in the user data area requires to read the seed information from the information recording medium, generate keys (block keys) based on the seed information, and execute decryption processing by use of the generated block keys.

As shown in FIG. 6(c), seed information (seed 1) necessary for generating block key Kb1 and seed information (seed 2) necessary for generating block key Kb2 are stored on the information recording medium. At the same time, seed information (seed 2) is stored as encrypted by block key Kb1 generated by seed information (seed 1). A program map table (PMT) including authoring studio code (ASC) and disc manufacturer code (DMC) is stored in the encrypted content. In addition, content authoring studio code (ASC: Authoring Studio Code) and disc manufacturer code (DMC: Disc Manufacturer Code) are also stored as electronic watermark (WM: WaterMark).

Thus, the data on which encryption processing is executed by use of two different keys is stored in the recording medium and the encrypted data is decrypted by applying the two keys at the time of reproduction.

After the decryption processing executed on one processing unit basis, the decrypted transport stream packet is inputted in an MPEG-2 decoder and executed decoding process, and the decoded packet is reproduced. One processing unit (three sectors) includes 32 transport stream (TS) packets for example. Namely, 32×192=6144-byte data is regarded as one encryption and decryption processing unit. It should be noted that other processing units may be set as required.

At the time of decryption and reproduction, two pieces of seed information (seed 1 and seed 2) are obtained from the information recording medium for each processing unit, two block keys Kb1 and Kb2 are generated on the basis of the obtained seed information, and decryption processing is executed by use of the generated block keys Kb1 and Kb2, thereby reproducing the content.

At the recording of content, the processing which is reverse to the decryption and reproduction processing is executed; namely, two pieces of seed information (seed 1 and seed 2) are set for each processing unit, two block keys Kb1 and Kb2 are generated on the basis of the seed information, and the encryption processing is executed by use of the generated block keys Kb1 and Kb2, thereby recording the content.

As described above, each content recording medium such as DVD stores the encrypted content and a program map table PMT (Program Map Table) including authoring studio code (ASC) and disc manufacturer code (DMC). The program map table PMT including these codes is embedded in the content at the content authoring entity 330 (refer to FIG. 2).

The following describes a method in which the program map table PMT including authoring studio code (ASC) and disc manufacturer code (DMC) is embedded in content. It should be noted that authoring studio code (ASC) and disc manufacturer code (DMC) may be not only the code data set as authoring studio identifier and disc manufacturer identifier as described before but also the setting codes for each disc manufacturing unit (or lot) and each order unit or the codes set for each piece of content to be stored in each recording medium. Further, these codes may be set as the codes which include the date and time of ordering or manufacturing the content storage recording medium.

In the present embodiment, an example of application of authoring studio code (ASC) and disc manufacture code (DMC) is described as identification codes. It is also practicable in the present embodiment to give identification information (or codes) corresponding to the entities managed by the trusted center, various entities which exist in the processes of manufacturing and distribution of content recording media for example, thereby enabling the management based on the identification codes to be given to these entities. The following describes an exemplary management configuration in which the entities to be managed by the trusted center are an authoring studio and a disc manufacturer, and the identification codes corresponding to these entities are authoring studio code (ASC) and disc manufacturer code (DMC).

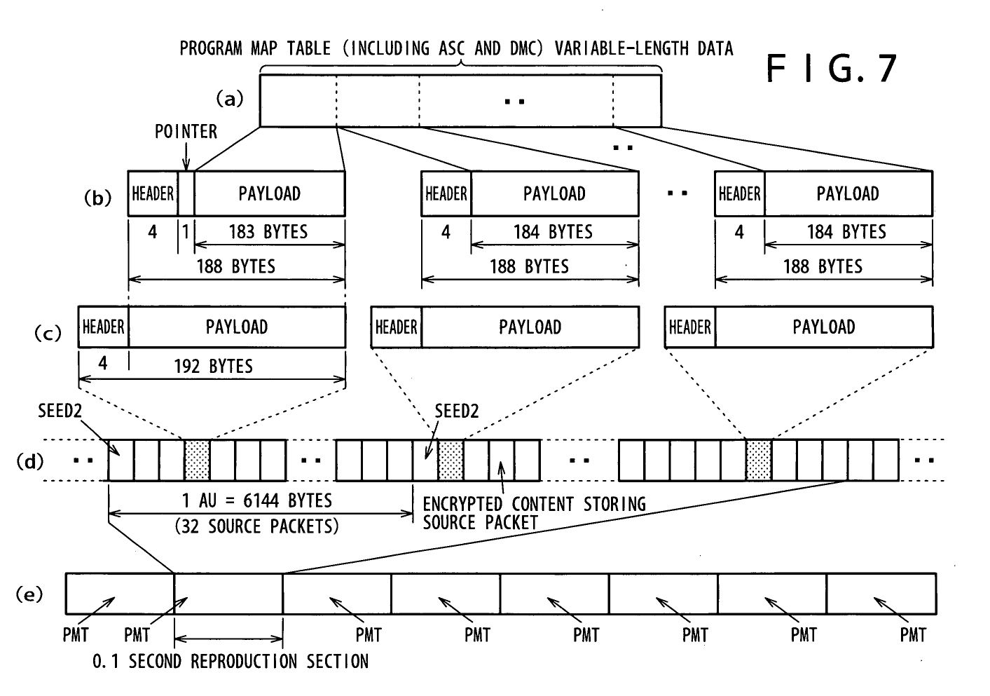

FIG. 7 shows an example in which program map table PMT data including authoring studio code (ASC) and disc manufacturer code (DMC) is inserted in content. A program map table PMT shown in FIG. 7(a) is set as information which includes various control information and identification information in addition to authoring studio code (ASC) and disc manufacturer code (DMC), and has a variable data length.

As shown in FIG. 7(b), this program map table (PMT) is stored as divided into payload portions of two or more TS packets (188 bytes long each). The number of TS packets corresponds to the data length of the program map table (PMT). Each payload is preceded by a 4-byte TS packet header. Each TS packet storing the divided data of the program map table (PMT) is further attached with timestamp information and copy control information (CCI: Copy Control Information) as shown in FIG. 7(c) to provide a source packet (192 bytes long).

The encrypted content itself stored in a recording medium also consists of many source packets. Program map table (PMT) data stored source packets (PMT packets) are arranged in each encrypted content stored source packet in a distributed manner as shown in FIG. 7(d). The location of each PMT packet in a content packet is not specified and therefore each PMT packet can be arranged at any position.

However, it is necessary for the PMT packets to be stored such that the entire program map table (PMT) data can be read within a certain content reproduction period (0.1 second for example). As shown in FIG. 7(e), the entire data of the program map tables (MPT) distributed as two or more packets in a content source packet sequence is arranged so that it can be read repeatedly within a certain reproduction period (0.1 second for example).

As shown in FIG. 7(d), a collection of 32 source packets provides one unit (1 AU: Aligned Unit) of 6144 bytes which is encryption processing unit, which has the configuration described above with reference to FIG. 6. If content is recorded by use of the transport stream format specified in the ISO/IEC 13818-1:1996 (MPEG system), it is necessary to record the above-mentioned program map table (PMT). The PMT is recorded to a TS packet having PID specified by PAT (Program Association Table).

However, the related-art program map table (PMT) does not define the recording of authoring studio code (ASC) and disc manufacturer code.(DMC) described herein. The processing of embedding authoring studio code (ASC) and disc manufacturer code (DMC) to be executed at each authoring studio will be detailed later.

[Configuration of Information Processing Device]

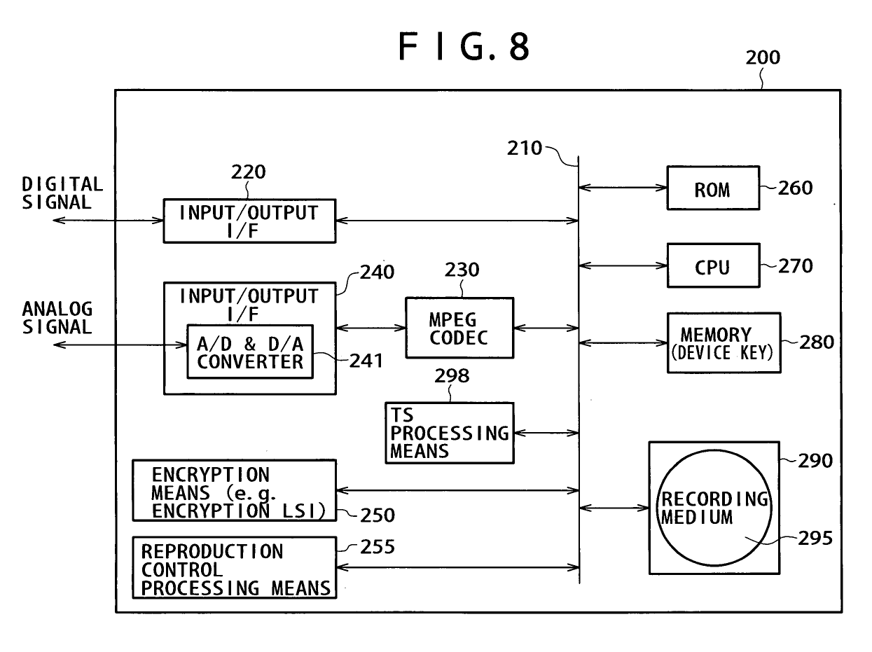

Referring to FIG. 8, there is shown a block diagram illustrating the information processing device 200 practiced as one embodiment of the invention for executing the processing of recording/reproducing content having the above-mentioned encrypted content form described above. The information processing device 200 has a input/output I/F (Interface) 220, an MPEG (Moving Picture Experts Group) codec 230, an input/output I/F (Interface) 240 having an A/D & D/A converter 241, encryption processing means 250, reproduction control processing means 255, a ROM (Read Only Memory) 260, a CPU (Central Processing Unit) 270, a memory 280, a drive 290 of a recording medium 295, and transport stream processing means (or TS processing means) 298, which are interconnected by a bus 210.

The input/output I/F 220 receives a digital signal constituting various pieces of content such as image, sound, and program supplied from the outside, outputting it to the bus 210, and receives a digital signal from-the bus 210, outputting it to the outside. The MPEG codec 230 MPEG-decodes the MPEG-encoded data supplied via the bus 210, outputting the decoded data to the input/output I/F 240, and MPEG-encodes a digital signal supplied from the input/output I/F 240, outputting the encoded signal to the bus 210. The input/output I/F 240 incorporates the A/D & D/A converter 241. The input/output I/F 240 receives an analog signal supplied as content from the outside and A/D-converts the received signal through the A/D & D/A converter 241, outputting the resultant digital signal to the MPEG codec 230, and D/A-converts a digital signal supplied from the MPEG codec 230 through the A/D & D/A converter 241, outputting the resultant analog signal to the outside.

The encryption processing means 250, based on a single-chip LSI (Large Scale Integrated Circuit) for example, encrypts or decrypts a digital signal supplied via the bus 210 as content, outputting the resultant signal to the bus 210. The reproduction control processing means 255 executes various processing operations for verification in content reproduction. If no reproduction condition is satisfied, the reproduction control processing means 255 stops content reproduction processing. The encryption processing means 250 and the processing executed thereby will be detailed later.

It should be noted that the encryption processing means 250 is not restricted to a single-chip LSI; a combination of various software programs or hardware devices may also be used to constitute the encryption processing means. In the figure, the encryption processing means 250 and the reproduction control processing means 255 are shown as separate blocks; these blocks may also be practiced as the processing which is executed by a program to be executed under the control of the CPU 270, for example.

The ROM 260 stores a device key unique to each information processing device or unique to each group of information processing devices and an authentication key necessary for mutual authentication. The device key is used to get a media key by decrypting EKB (Enabling Key Block) as the encrypted key block information which is provided on the basis of a key distribution tree structure, for example. Namely, the device key is applied as media key generating information.

The CPU 270 executes programs stored in the memory 280 to control the MPEG codec 230, the encryption processing means 250, and so on. The memory 280, which is a nonvolatile memory for example, stores programs to be executed by the CPU 270 and the data necessary for the operation of the CPU 270. If the memory 280 is a nonvolatile memory, it can also store the device key; in the description of following embodiments of the invention, it is assumed that the device key be stored in the memory 280. The drive 290 drives the recording medium 295 on which digital data can be recorded and reproduced to read (or reproduce) digital data from the recording medium 295, outputting the digital data to the bus 210, and supplies digital data received from the bus 210 to the recording medium 295, recording the supplied digital data thereto.

The recording medium 295 is a digital data recordable medium such as the optical disc like DVD or CD, magneto-optical disc, the magnetic disc, the magnetic tape, or the semiconductor memory like flash ROM, MRAM, or RAM, for example, providing an information recording medium which stores various data described with reference to FIG. 1. In the present embodiment of the invention, the recording medium 295 is removable from the drive 290. However, it is also practicable for the recording medium 295 to be incorporated in the information processing device 200.

The transport stream processing means (TS processing means) 298 executes data processing for extracting the transport stream packet corresponding to a particular piece of content from a transport stream multiplexed with two or more pieces of content, and stores the information about a timing at which the extracted transport stream occurs into the recording medium 295 along with each packet. Also, at the time of decryption and reproduction, the transport stream processing means 298 execute the processing of transport stream occurrence timing control.

As described before, each transport stream has ATS (Arrival TimeStamp) as transport packet occurrence timing information. Timing control is executed on the basis of ATS at the time of decryption by the MPEG2 decoder. If transport packets are recorded to a recording medium for example, the transport stream processing means (TS processing means) 298 records them as source packets with their intervals closed up. Storing the occurrence timing of each transport packet into the recording medium along with each transport packet allows the control of the occurrence timing of each packet at the time of reproduction.

The information processing device 200 according to the invention executes the recording/reproduction of the encrypted content made up of the above-mentioned transport stream, for example. The details of these processing operations will be described later. It should be noted that the encryption processing means 250 and the transport stream processing means (TS processing means 298 shown in FIG. 8 are shown as separate block for ease of understanding; it is also practicable to configure these means as a single-chip LSI which executes both functions or realize these functions by a combination of software programs or hardware devices. Besides, it is also practicable to configure all blocks except for the drive 290 and the recording medium 295 as a single-chip LSI or realize these functions by a combination of software programs or hardware devices, thereby enhancing the robustness against the revocation of security capabilities due to the alteration of the information processing device 200.

[Data Reproduction Processing]

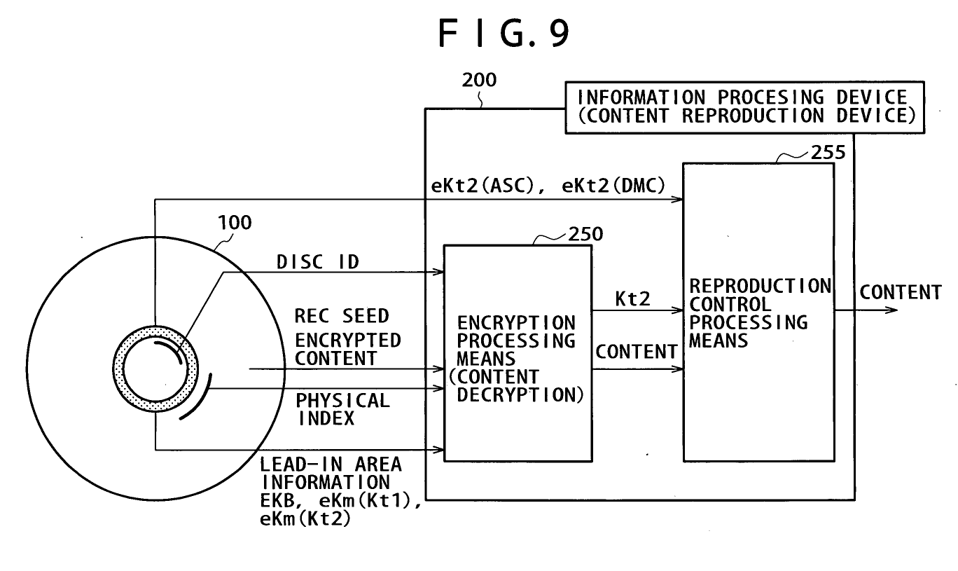

The following describes the decryption processing and reproduction control processing of the encrypted data stored in a recording medium. As shown in FIG. 9, the content reproduction in the information processing device 200 includes two steps of the decryption processing of the encrypted content in the encryption processing means 250 and the reproduction control processing in the reproduction control processing means 255.

Various kinds of information are read from the information recording medium 100, the encrypted content is decrypted by the encryption processing means 250, the decrypted content is passed to the reproduction control processing means 255 to determine the reproduction condition, and, if the reproduction condition is found satisfied, the content reproduction is continued; otherwise, the content reproduction is discontinued.

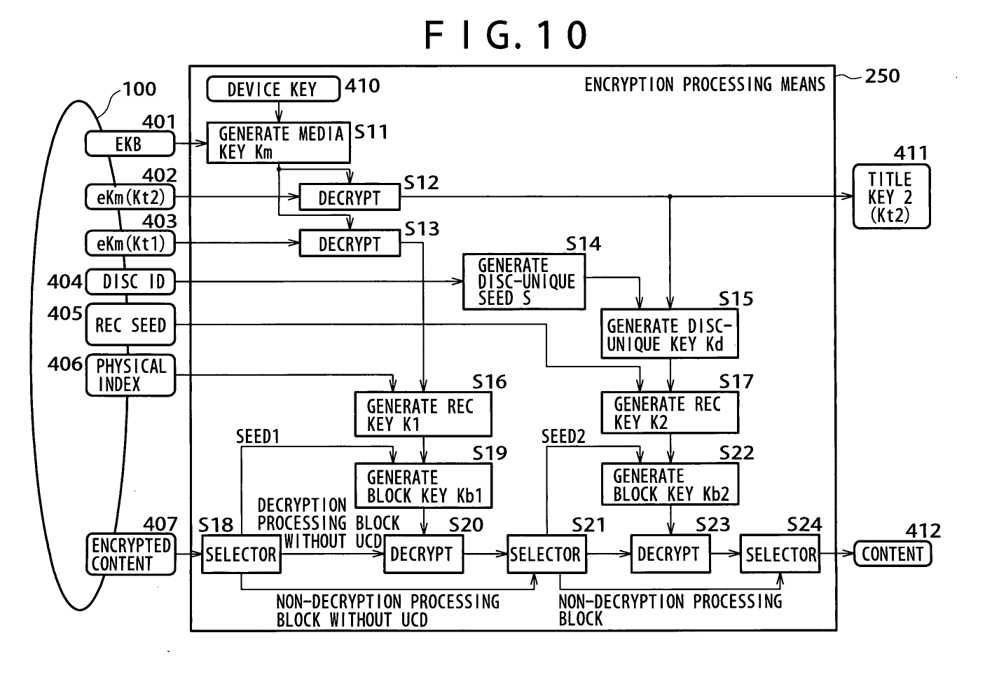

First, the following describes the details of the processing of decrypting encrypted content in the encryption processing means 250 with reference to FIG. 10 and on.

In the content decryption process, the encryption processing means 250 reads a device key 410 from the memory. The device key 410 is a private key stored in each information processing device licensed for content usage.

Next, in step S11, the encryption processing means 250 executes decryption of the media key stored EKB stored in the information recording medium 100 by applying the device key 410, thereby obtaining media key Km.

In step S12, encrypted second title key eKm(Kt2) encrypted by media key Km stored in the information recording medium 100 is decrypted by use of media key Km obtained in the EKB processing of step S11, thereby obtaining second title key Kt2. Second title key Kt2 is outputted to the reproduction control processing means 255.

In step S13, the encrypted first title key eKm(Kt1) encrypted by media key Km stored in the information recording medium 100 is decrypted by use of media key Km obtained in the EKB processing of step S11, thereby obtaining first title key Kt1.

In step S14, disc-unique seed (S) is obtained from the disc ID stored in the information recording medium 100. The encryption processing means 250 reads a disc ID 404 which is the identification information stored in the information recording medium 100 to execute the verification of the disc ID 404. The disc ID is data (S, Sig) having seed S which is different for each disc and electronic signature (Sig) for alteration verification, which are generated by the trusted center 300. The encryption processing means 250 reads the ID information (S, Sig) from the information recording medium 100 to check for any ID alteration by the signature verification processing. In the case of the signature based on the public key cryptography, the signature verification by the public key of the trusted center 300 is executed. In the case of the common key cryptography, the signature verification processing is executed by use of the common key. If no ID alteration is found by the signature verification processing, then, in step S14, disc-unique seed S is obtained from the disc ID stored in the information recording medium 100. If any ID alteration is found by the signature verification processing, then the content decryption processing comes to a halt.

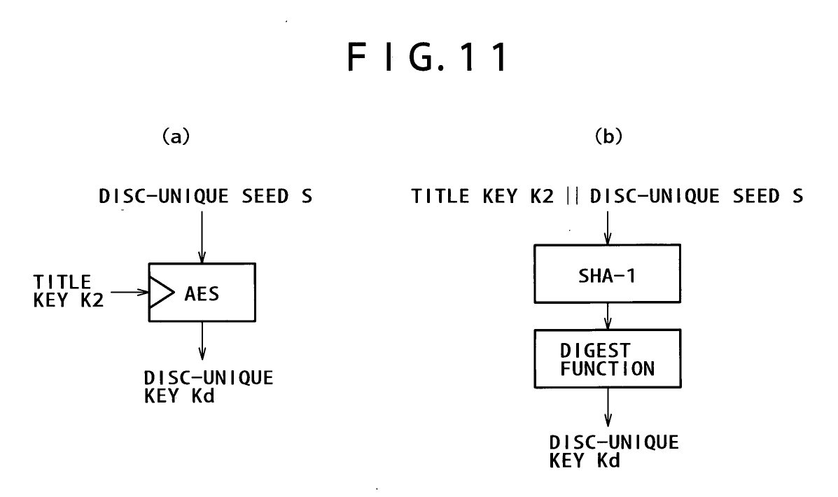

If no ID alteration is found by the signature verification processing, then, in step S15, disc-unique key Kd is generated by use of disc-unique seed S and title key K2. The disc-unique key may be actually generated in any of the following methods for example. In one method, as shown in FIG. 11(a), with disc-unique seed S used as an input value, AES (Advanced Encryption Standard) which is a common key cryptography is executed by use of title key K2 as the encryption key. In another method, as shown in FIG. 11(b), data generated by bit linkage between title key K2 and disc-unique seed S is inputted in hash function SHA-1 specified in FIPS 180-1 and a necessary data length is used from its output as disc-unique key.

Further, the encryption processing means 250 generates first record key (REC key) K1 in step S16 on the basis of first title key Kt1 generated in step S13 and a physical index 406 read from the information recording medium 100. Also, the encryption processing means 250 generates second record key (REC key) K2 in step S17 on the basis of disc-unique key Kd generated in step S15 and a record seed (REC SEED) 405 read from the information recording medium 100. In the generation of these keys, AES encryption processing, hash function, and digest function are applied appropriately.

Record keys K1 and K2 are required for use in the above-mentioned reproduction processing. The keys and recording processing which are applied in also in the encryption processing for recording content to information recording media will be described later.

When two record keys (REC keys) 1 and 2 have been generated in steps S16 and S17, then the procedure goes to step S18 in which encrypted content 407 is read from the information recording medium 100 and decrypted by two block keys Kb1 and Kb2.

In step S18, seed information (seed 1) included in the control information (UCD: User Control Data) is obtained from the encrypted content 407 stored in the information recording medium 100. In step S19, the encryption processing based on seed information (seed 1) and first recording key K1 generated in step S16 is executed to generate block key Kb1.

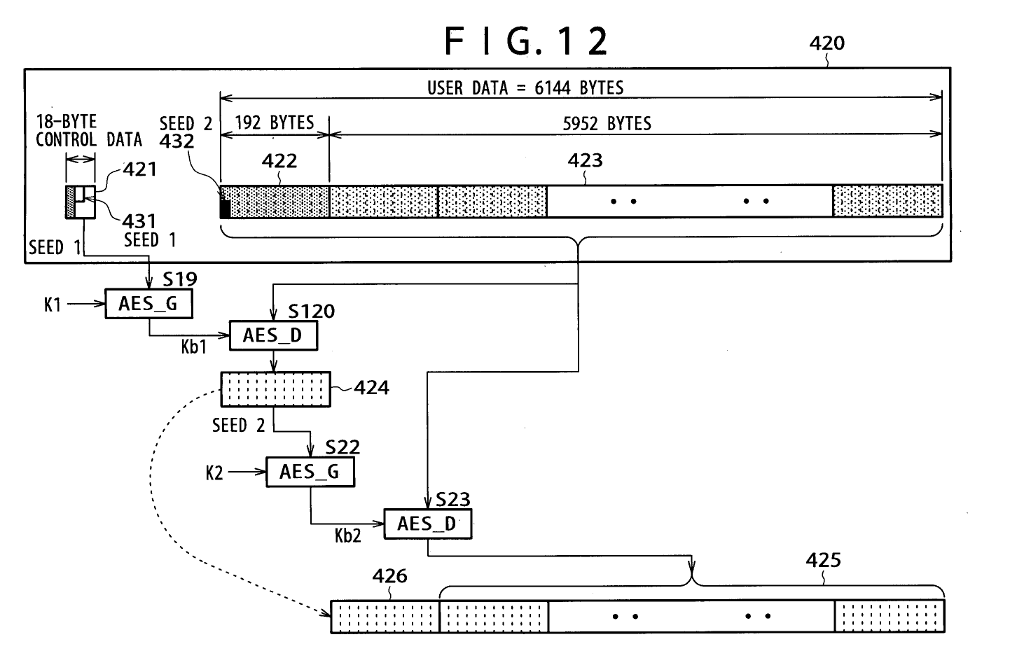

The following describes the processing which is executed subsequent to the processing of generating block key Kb1 of step S19, with reference to FIGS. 10 and 12.

In FIG. 12, the decryption processing is executed in processing unit 420. This processing unit is equivalent to (b) processing unit described before with reference to FIG. 6. Namely, this processing unit is one unit (1 AU: Aligned Unit) which is encryption processing unit. The encryption processing means 250 which executes the reproduction of the encrypted data stored in the information recording medium 100 extracts 1 AU (Aligned Unit) which is encryption processing unit on the basis of the flag in the control data.

Processing unit 420 includes 18-byte control data (UCD: User Control Data) 421 and 6144-byte user data (including encrypted content). The 6144-byte user data is divided by 192 bytes which are the unit of transport stream packet. The following separately describes a TS packet 422 at the beginning of the user data and a subsequent 5952-byte TS packet group 423. In this example, seed information (seed 1) 431 is stored in control data 421 and seed information (seed 2) 432 is stored in the TS packet 422, in an encrypted form.

It should be noted that there are two or more ways in which the storage of seed information, seed 1 and seed 2, is stored. In what follows, only one of them is shown. The other methods will be described later.

With reference to FIG. 12, processing steps similar to those previously described with reference to FIG. 10 are denoted by the same numbers.

In step S19 (FIGS. 10 and 12), seed information (seed 1) 431 read from the control data stored in the information recording medium is inputted in an AES encryption processing block to execute AES encryption processing applied with record key K1 generated before in step S16, thereby generating block key Kb1. AES_G shown in FIG. 12 denotes key generation processing applied with AES encryption processing and AES_D denotes data decryption applied with AES encryption processing.

In step S20 (refer to FIGS. 10 and 12), AES decryption processing applied with block key Kb1 generated in step S19 is executed. In step S20, only the data part on which encryption processing applied with block key Kb1 is performed is decrypted. In this example, a data area which includes at least seed information (seed 2) of the start TS packet 422 of the user data is the data part on which encryption processing applied with block key Kb1 is performed. Therefore, the decryption processing applied with block key Kb1 is executed on the data area which includes this seed information (seed 2).

It should be note that there are several patterns in which the data part on which the encryption processing applied with block key Kb1 is performed is related to which data area, which will be described later.

The start TS packet 422 includes seed information (seed 2) 432 which is necessary for calculating block key Kb2 to be applied to the decryption of another user data part, namely, the subsequent 5952-byte TS packet group 423. Namely, seed information (seed 2) 432 is recorded to the start TS packet 422 as the encrypted data on which the encryption processing applied with block key Kb1 has been performed.

As a result of the decryption processing applied with block key Kb1 in step S20, a decrypted TS packet 424 is calculated, from which seed information (seed 2) is extracted.

In selector step S21 shown in FIG. 10, from the result of the decryption processing applied with block key Kb1, seed information (seed 2) is outputted to block key Kb2 generating step of step S22, the encrypted data encrypted by block key Kb2 is outputted to decryption step S23, and other decrypted data (non-encrypted data) to selector step S24.

In step S22 (refer to FIGS. 10 and 12), AES encryption processing is executed on the basis of seed information (seed 2) extracted from the decrypted TS packet 424 obtained as a result of the decryption processing applied with block key Kb1 in step S20 and record key K2 generated in step S17 (refer to FIG. 10), thereby calculating block key Kb2.

Next, in step S23, the encrypted part (a data area 423 encrypted by block key Kb2) of the user data part is decrypted by applying block key Kb2 to generate a decrypted TS packet group 425.

The decrypted TS packet group 425 and a decrypted TS packet 426 (=decrypted TS packet 424) are linked in selector step S24 to be inputted in the reproduction control processing means 255 as content 412 composed of decrypted TS packets.

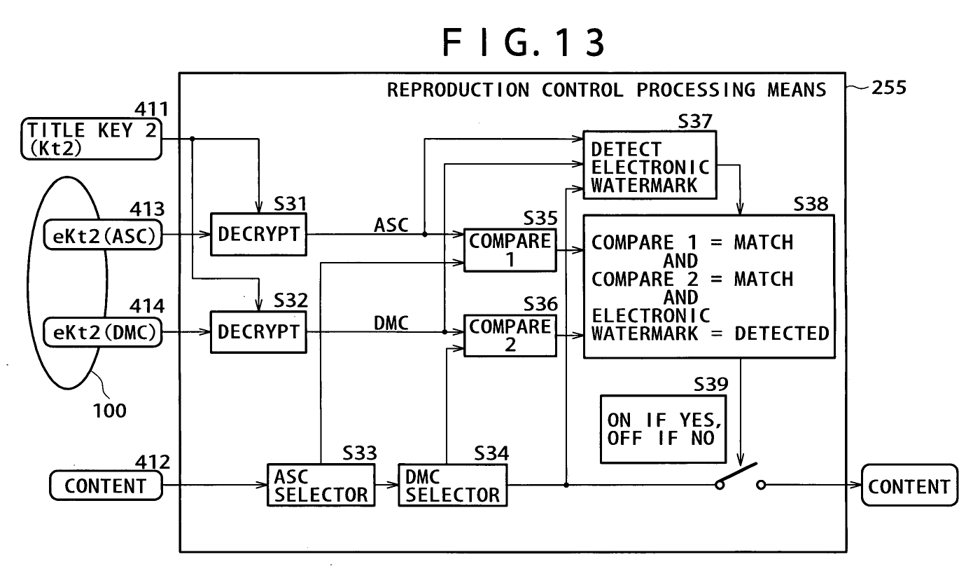

The following describes the reproduction control processing which is executed in the reproduction control processing means 255 with reference to FIG. 13. The reproduction control processing means 255 receives second title key (Kt2) 411 and the decrypted content 412 from the encryption processing means 250.

First, in step S31, the reproduction control processing means 255 reads encrypted ASC, namely, data eKt2(ASC) which is the authoring studio code (ASC: Authoring Studio Code) encrypted by second title key (Kt2), from the information recording medium 100 and decrypts this data by applying second title key (Kt2) received from the encryption processing means 250, thereby obtaining an authoring studio code (ASC), which is stored in the memory.

Further, in step S32, the reproduction control processing means 255 reads encrypted DMC, namely, data eKt2 (DMC) which is disc manufacturer code (DMC) encrypted by second title key (Kt2), from the information recording medium 100 and decrypts this data by applying second title key (Kt2) received from the encryption processing means 250, thereby obtaining a disc manufacturer code (DMC), which is stored in the memory.

The reproduction control processing means 255 detects, from the decrypted content 412 received from the encryption processing means 250, a program map table (PMT: Program Map Table) which includes authoring studio code (ASC) and disc manufacturer code (DMC). The PMT is the information which includes authoring studio code (ASC) and disc manufacturer code (DMC), which is embedded in the content at the content authoring entity 330. In step S33, authoring studio code (ASC) detection is executed. In step S34, disc manufacturer code (DMC) detection is executed.

In step S35, the authoring studio code (ASC) detected from the PMT is compared with the authoring studio code (ASC) obtained by the decryption of encrypted authoring studio code eKt2 (ASC) and stored in the memory.

In step S36, the disc manufacturer code (DMC) detected from the PMT is compared with the disc manufacturer code (DMC) obtained by the decryption of the encrypted disc manufacturer code (DMC) eKt2 (DMC) and stored in the memory.

In step S37, the electronic watermark including authoring studio code (ASC) and disc manufacturer code (DMC) is detected from the content 412 within a specified time to determine whether the electronic watermark stored information matches the memory stored information. In the reproduction control processing means 255, its timer is set from the beginning of content reproduction to determine whether the electronic watermark including authoring studio code (ASC) and the disc manufacturer code (DMC) has been detected within a predetermined period of time.

In step S38, it is determined whether matches have been found all in the comparison in step S35, namely the comparison between the authoring studio code (ASC) detected from the PMT and the authoring studio code (ASC) stored in the memory, and the comparison in step S36, namely, the comparison between the disc manufacturer code (DMC) detected from the PMT and the disc manufacturer code (DMC) stored in the memory, and whether the electronic watermark within a predetermined period of time in step S37 have been detected and matched.

In step S39, the content reproduction is continued if the determination in step S38 is Yes; if the determination in step S38 is No, the content reproduction is stopped.

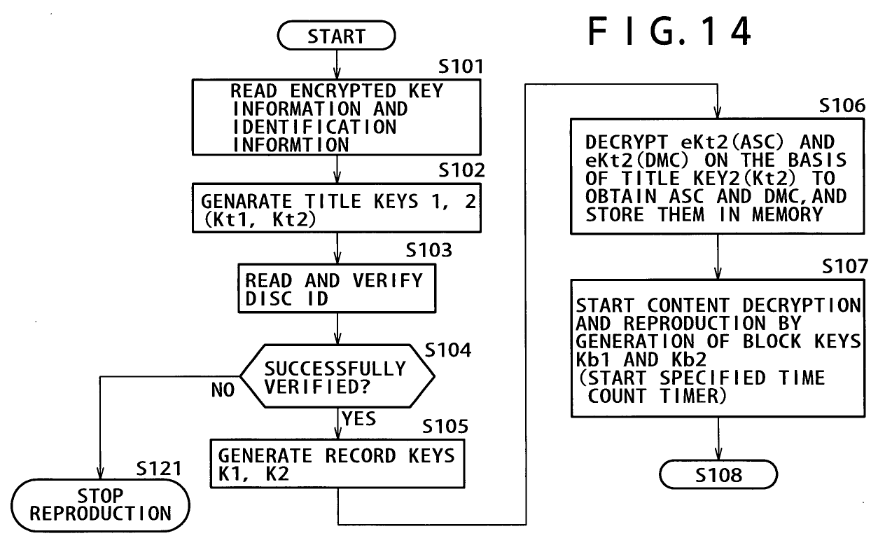

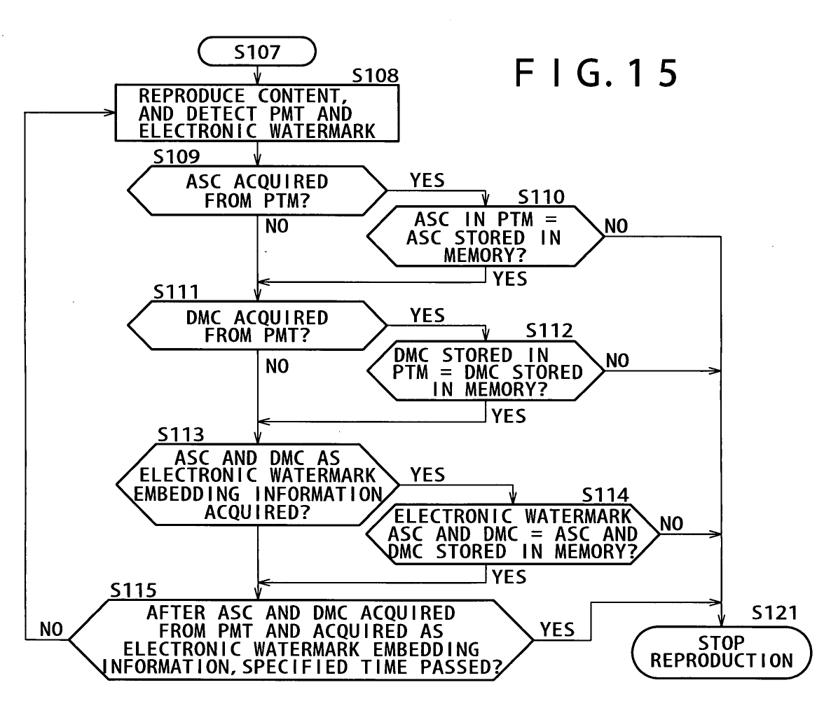

The following describes, with reference to FIGS. 14 and 15, a sequence of content reproduction processing in the information processing device as a user device on which content reproduction is executed.

In step S101, the information processing device (or the user device) reads cryptographic key information and identification information from the information recording medium. In step S102, title keys (Kt1, Kt2) are generated on the basis of the information read above and the device key stored in the information processing device concerned.

In step S103, disc ID (S, Sig) is read from the information recording medium and this disc ID is verified. If the verification fails, the content reproduction stops at this point of time. If the disc ID is found successfully verified, then record keys K1 and K2 are generated in step S105.

In step S106, the encrypted ASC and the encrypted DMC read from the information recording medium on the basis of second title key (Kt2), namely, eKt2(ASC) and eKt2 (DMC), are decrypted, thereby storing the resultant authoring studio code (ASC) and disc manufacturer code (DMC) into the memory.

In step S107, block keys Kb1 and Kb2 are generated and the content is decrypted and reproduced on the basis of the generated block keys Kb1 and Kb2.

In step S108, the detection of PMT and electronic watermark is executed, while executing content reproduction. If the authoring studio code (ASC) is detected from the PMT in step S109, then the authoring studio code (ASC) detected in step S109 is compared with the authoring studio code (ASC) stored in the memory in step S110. If no match is found, then the content reproduction is stopped in step S121.

If a match is found, then the procedure goes to step Sill. If the disc manufacturer code (DMC) is found from the PMT, then the procedure goes to step S112, in which the detected disc manufacturer code (DMC) is compared with the disc manufacturer code (DMC) stored in the memory. If no match is found, the content reproduction is stopped in step S121.

If a match is found, then the procedure goes to step S113. If authoring studio code (ASC) and disc manufacturer code (DMC) are detected from the electronic watermark information, then the procedure goes to step S114, in which the authoring studio code (ASC) detected in step S114 is compared with the authoring studio code (ASC) stored in the memory and the disc manufacturer code (DMC) detected in step S114 is compared with the disc manufacturer code (DMC) stored in the memory. If no match is found, the content reproduction is stopped in step S121.

In step S115, it is determined whether the PMT and the electronic watermark information of authoring studio code (ASC) and disc manufacturer code (DMC) have been detected within a predetermined period of time. If the PMT and the electronic watermark are found not detected, then the content reproduction is stopped in step S121.

The processing of detecting the PMT and the electronic watermark of authoring studio code (ASC) and disc manufacturer code (DMC) is repeated at predetermined time intervals. As described with reference to FIG. 7, the PMT including authoring studio code (ASC) and disc manufacturer code (DMC) is repeatedly recorded at certain read time intervals (0.1 second of reproduction interval, for example). The reproducing device repeatedly reads these pieces of information to execute comparison processing. The same holds with the electronic watermark. Therefore, in a reproduction process started halfway in a particular piece of content, the verification of authoring studio code (ASC) and disc manufacturer code (DMC) based on PMT and electronic watermark can also be executed without failure.

However, if the PMT and the electronic watermark of one authoring studio code (ASC) and one disc manufacturer code (DMC) have been detected and, if a match is found with the memory stored information, the subsequent record verification processing may be omitted.

As described above, the content stored in the information recording medium is encrypted by block keys Kb1 and Kb2 generated by seed information (seed 1) and seed information (seed 2). Because seed information (seed 2) is encrypted by the key generated by use of seed information (seed 1), namely block key Kb1, and the encrypted seed information is stored, the direct reading of the encrypted information from the information recording medium cannot be practiced, thereby enhancing the robustness against the analysis of seed information (seed 2), the analysis of block key Kb2 generated by use of seed information (seed 2), and the analysis of the encryption algorithm in which user data is encrypted by block key Kb2.

Further, in the present configuration, authoring studio code (ASC) and disc manufacturer code (DMC) are stored in the information recording medium along with the encrypted content and the encrypted content is reproduced only when these codes are successfully detected and verified, thereby stopping the reproduction of the content stored in a medium having an unauthorized code or an information recording medium having no code and allowing reproduction of only the content stored recording media manufactured on the basis of an authorized manufacturing route. If the replication of unauthorized information recording media is manufactured and distributed, the detection of authoring studio code (ASC) and disc manufacturer code (DMC) allows the tracing of an information leakage route with ease.

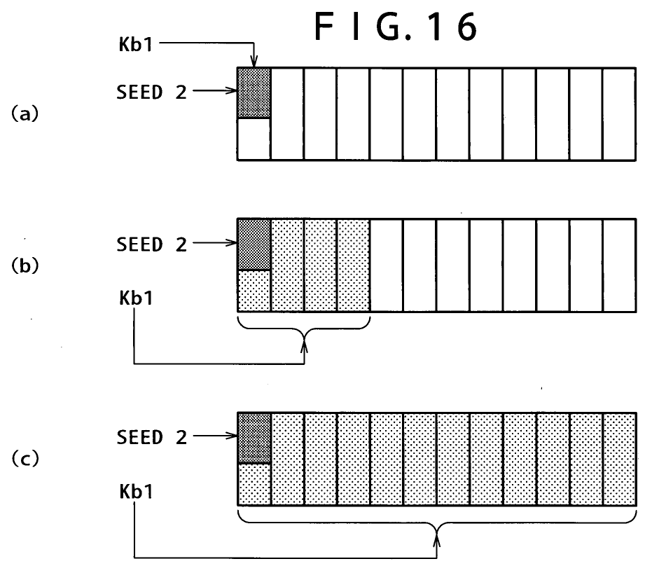

The following describes an exemplary area which is encrypted by block key Kb1 generated on the basis of seed information (seed 1) and record key K, with reference to FIG. 16. FIG. 16 shows an example in which seed information (seed 1) is stored in the control block and seed information (seed 2) is included in one TS packet of user data. As described above with reference to FIG. 12, seed information (seed 2) is 128-bit data for example. For this information, the information included in the head part of the head packet of one encryption processing unit (1 AU) is applied.

If seed information (seed 2) is stored in the packet, exemplary areas which are encrypted by block key Kb1 generated by seed information (seed 1) and record key K1 are as shown in FIG. 16(a) through FIG. 16(c). FIG. 16(a) shows an example in which only seed information (seed 2) is encrypted by block key Kb1. The other areas are made non-encrypted areas or the data areas encrypted by block key Kb2 generated by seed information (seed 2) and record key K2.

FIG. 6(b) shows an example in which a partial area of a TS packet including seed information (seed 2) is encrypted by block key Kb1.

FIG. 6(c) shows an example in which the entire area of one TS packet including seed information (seed 2) is encrypted by block key Kb1.

Thus, various manners of storing seed information (seed 1) and seed information (seed 2) and setting encrypted data areas are possible. However, in each manner, seed information (seed 2) is encrypted for storage by the key generated by use of seed information (seed 1), namely, block key Kb1, so that the direct reading from the information recording medium is made impossible, thereby enhancing the robustness against the analysis of seed information (seed 2), the analysis of block key Kb2 generated by use of seed information (seed 2), and the analysis of the encryption algorithm in which user data is encrypted by block key Kb2.

[Processing of Storing Data Into Information Recording Media]

As described before with reference to FIG. 2, each information recording medium in which encrypted content is stored is authored at the content authoring entity (AS: Authoring Studio) 330 and then replicated in lump in the form of CD or DVD at information recording medium manufacturing entity (DM: Disc Manufacturer) 350 as the medium to be provided to users. This medium is the information recording medium 100 herein.

The management on the above-mentioned disc manufacturer, sale, and use processing is executed by the trusted center (TC) 300. The trusted center 300 provides various kinds of management information to the content authoring entity (AS: Authoring Studio) 330 and the information recording medium manufacturing entity (DM: Disc Manufacturer) 350. On the basis of the management information supplied by the trusted center 300, the content authoring entity (AS: Authoring Studio) 330 and the information recording medium manufacturing entity (DM: Disc Manufacturer) 350 execute content authoring, encryption, and generation and storage of key information.

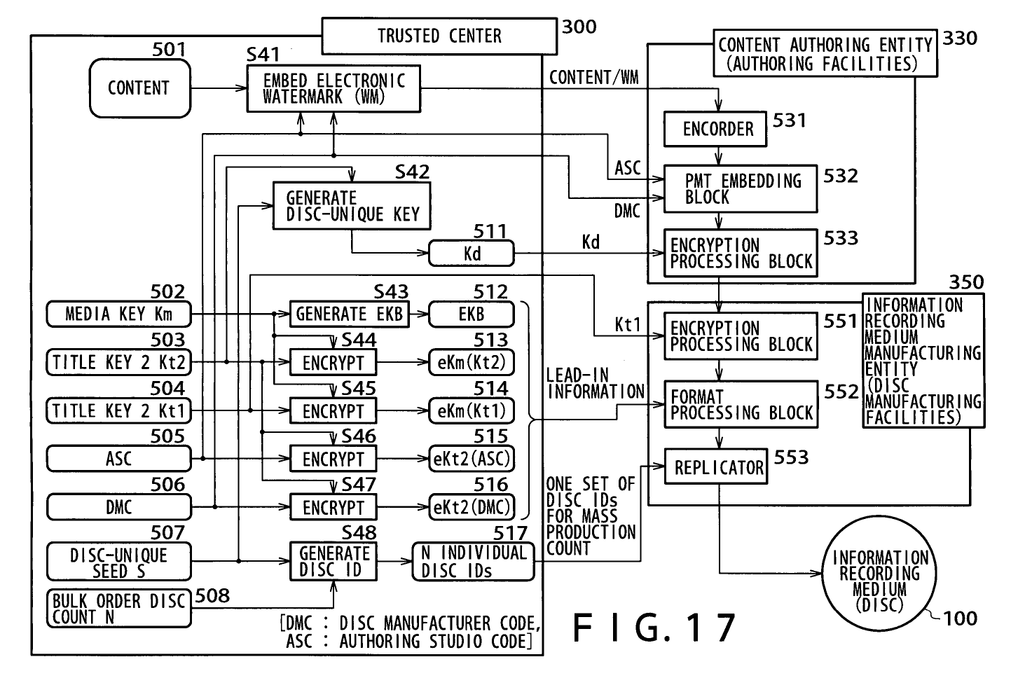

The following describes the details of the processing to be executed by the trusted center 300, the content authoring entity 330, and the information recording medium manufacturing entity 350, with reference to FIGS. 17 and on.

FIG. 17 shows the processing to be executed by the trusted center 300, the content authoring entity 330, and the information recording medium manufacturing entity 350.

The trusted center 300 holds content 501 given by a content owner and, in correspondence to the content or media to be stored in information recording media which are media to be manufactured, sets media key Km 502, second title key Kt2 503, first title key Kt1 504, authoring studio code (ASC) 505, disc manufacturer code (DMC) 506, disc-unique seed S 507, the number of information recording media permitted to be manufactured and bulk order disc count N 508.

In step S41, the trusted center 300 embeds authoring studio code (ASC) 505 and disc manufacturer code (DMC) 506 into the content 501 supplied by the content owner as electronic watermark.

In step S42, disc-unique key Kd 511 is generated on the basis of disc-unique seed S 507.

The trusted center 300 provides the content embedded with electronic watermark, authoring studio code (ASC) 505, disc manufacturer code (DMC) 506, and disc-unique key Kd 511 generated on the basis of disc-unique seed S 507 to the content authoring entity 330.

In step S43, the trusted center 300 generates EKB 512 as a cryptographic key block having a configuration in which media key Km 502 can be obtained only with the device key of the user device having a license as the content reproduction right.

In step S44, second title keys Kt2 503 is encrypted on the basis of media key Km 502 to generate encrypted second title key eKm(Kt2) 513. In step S45, first title key Kt1 504 is encrypted on the basis of media key Km 502 to generate encrypted first title key eKm(Kt1) 514.

In step S46, authoring studio code (ASC) 505 is encrypted by second title key Kt2 503 to generate eKt2 (ASC) 515 which is encrypted ASC. In step S47, disc manufacturer code (DMC) 506 is encrypted by second title key Kt2 503 to generate eKt2(DMC) 516 which is encrypted DMC.

Further, N (S, Sig), namely, N individual disc IDs 517 are generated on the basis of the number of information recording media permitted to be manufactured and bulk order disc count N 508, in correspondence with the disc-unique seed S 507.

EKB 512, encrypted second title key eKm(Kt2) 513, encrypted first title key eKm(Kt1) 514, eKt2(ASC) 515 which is encrypted ASC, eKt2(DMC) 516 which is encrypted DMC, N individual disc ID 517, and first title key Kt1 are provided from the trusted center 300 to the information recording medium manufacturing entity 350.

The following describes the processing to be executed by the content authoring entity 330. The content authoring entity 330 executes the encoding, MPEG encoding for example in a encoder 531, of the content embedded with electronic watermark supplied from the trusted center 300, thereby generating transport stream data, and executes, in a PMT (Program Map Table) embedding block 532, the embedding of authoring studio code (ASC) and disc manufacturer code (DMC) supplied from the trusted center 300. PMT is the information that includes authoring studio code (ASC) and disc manufacturer code (DMC), which are embedded in the content at the content authoring entity 330.

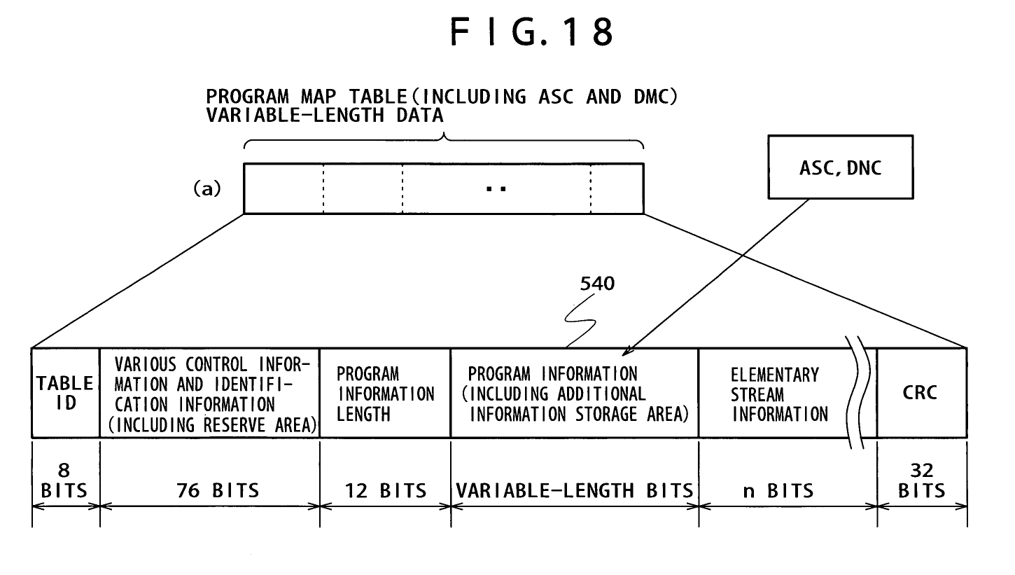

The following describes the details of embedding the PMT that includes authoring studio code (ASC) and disc manufacturer code (DMC), which is executed by the PMT (Program Map Table) embedding block 532, with reference to FIGS. 18 and on.

FIG. 18 shows a PMT configuration specified in ISO/IEC 13818-1: 1996 (MPEG system) and the storage locations of authoring studio code (ASC) and disc manufacturer code (DMC) proposed hereby.

ISO/IEC 13818-1: 1996 (MPEG system) specifies the data configuration of program map table (PMT) as shown in FIG. 18.

At the beginning, the storage position of 8-bit table ID is specified, followed by a 76-bit area for storing various control information and identification information. Subsequently, a 12-bit program information length storage area providing the data length information of the program information area is set, followed by a program information area 540 having a data length specified in the program information length. Subsequent to the program information area 540, elementary stream information is stored, for each data unit, as the control information in units of video data and audio data constituting the content, lastly followed by a 32-bit CRC (Cyclic Redundancy Code).

In the program information area 540, an area in which desired additional information may be stored may be set, in which authoring studio code (ASC) and disc manufacturer code (DMC) are stored. It should be noted that, as described before, authoring studio code (ASC) and disc manufacturer code (DMC) may be not only the code data set as authoring studio identifier and disc manufacturer identifier respectively but also the codes set for each piece of content to be stored in the recording medium. Besides, these codes may also be set as those which include the date information such as order date and manufacture date of each content stored recording medium.

These authoring studio code (ASC) and disc manufacturer code (DMC) are supplied from the trusted center 300 to the content authoring entity 330. The content authoring entity 330 embeds the supplied codes into the content must pass the code-embedded content to each disc manufacturer entity after surely encrypting the content on the basis of block key Kb2 generated by applying seed 2 in a encryption processing block 533 (refer to FIG. 17).

Namely, authoring studio code (ASC) and disc manufacturer code (DMC) can be known only by the trusted center 300 and the content authoring entity 330, thereby preventing these codes from being leaked outside.

Therefore, authoring studio code (ASC) and disc manufacturer code (DMC) must be surely arranged in the area to be encrypted on the basis of block key Kb2. Basically, most data areas of source packets storing content and program map table (PMT) are those areas which are encrypted by block key Kb2 generated by seed 2. However, only the storage area of seed 2 used for the information for generating block key Kb2 is outside the encrypted areas encrypted by block key Kb2. Therefore, control must be done such that the data area of authoring studio code (ASC) and disc manufacturer code (DMC) do not overlap the seed 2 area.

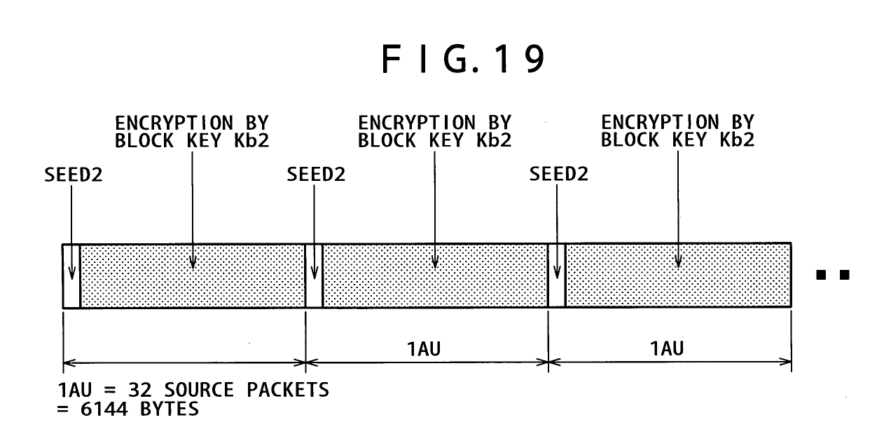

As shown in FIG. 19, seed 2 is set for each 1 AU (Aligned Unit) set as encryption processing unit, block key Kb2 as an encryption key is generated by use of seed 2 set for each processing unit, and each source packet data composed by content and program map table is encrypted for storage by the generated block key Kb2.

Therefore, when authoring studio code (ASC) and disc manufacturer code (DMC) are set to the area in which seed 2 at the start of 1 AU as encryption processing unit is located, these codes provides the information which is applied as seed 2. This consequently causes a problem of passing these codes from the content authoring entity 330 to a disc manufacturer entity in the form of plaintext without encryption by block key Kb2.

To prevent this problem from occurring, the PMT embedding block 532 of the content authoring entity 330 must execute PMT embedding processing in which the storage locations of authoring studio code (ASC) and disc manufacturer code (DMC) are controlled.

There are two methods in which the storage locations of authoring studio code (ASC) and disc manufacturer code (DMC) are controlled.

In the first method, of the 32 packets included in 1 AU (Aligned Unit) which is encrytption processing unit, program map table (PMT) is not arranged in each packet that includes the seed 2 area.

Unlike conventionally practiced MPEG-TS duplexing, control of the insertion position of PMT packet requires special duplexing processing in which the arrangement of PMT is prohibited for each head (the head on a 32-packet basis) of each encryption processing unit (AU: Aligned Unit). This PMT arrangement control can prevent authoring studio code (ASC) and disc manufacturer code (DMC) from being set to the seed 2 area. In this case, ASC and DMC may be written to any location in PMT.

In the other method, the writing positions of authoring studio code (ASC) and disc manufacturer code (DMC) are controlled in program map table (PMT), so that authoring studio code (ASC) and disc manufacturer code (DMC) will not overlap the seed 2 area if the PMT packet is located anywhere in content source packet.

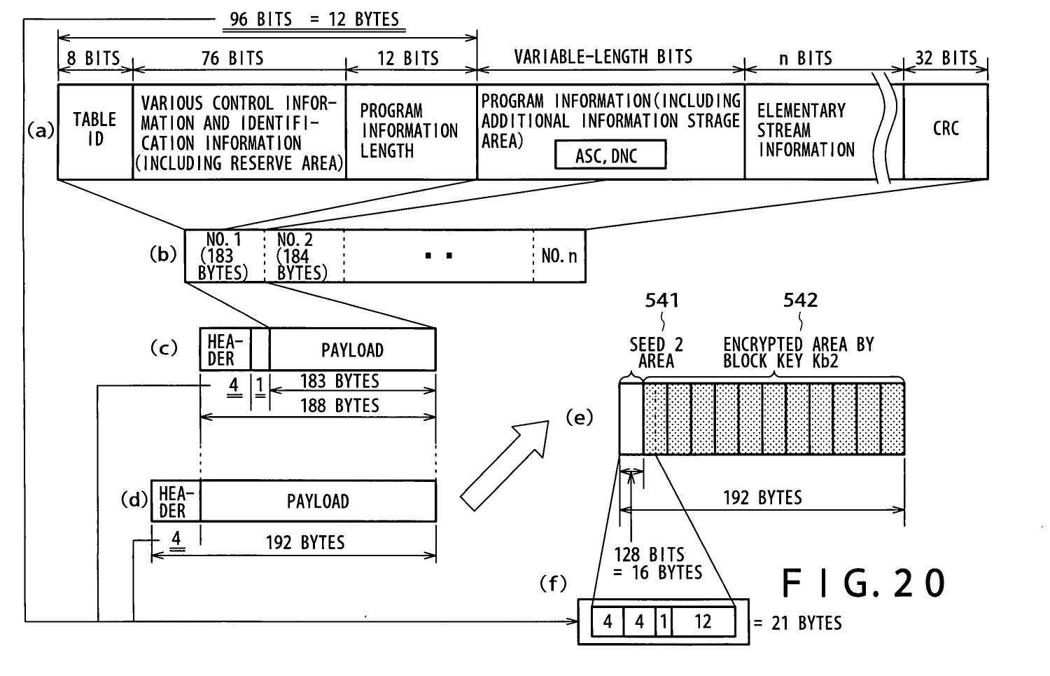

The method will be described with reference to FIG. 20. FIG. 20(a) shows the entire data of program map table PMT, which starts with 8-bit table ID, followed by 76-bit specified control information and identification information, and 12-bit program information length. Thereafter, program information is stored. As described above, authoring studio code (ASC) and disc manufacturer code (DMC) as additional information are stored in this program information area.

As shown in FIG. 20(b), program map table PMT is composed of the start 183-byte data and a subsequent 184-byte data sequence, which are stored as a payload of TS packets. For the first packet, the payload is preceded by 4-byte header information and 1-byte pointer information. In each subsequent packet, the payload is preceded by only 4-byte header information, as shown in (c). As shown in (d), each TS packet provides a source packet (192 bytes long) attached with header information such as timestamp and CCI and is set to a content source packet sequence in a scattered manner.

At this moment, a part which is possibly set as seed 2 is an area within the start area of 128 bits (or a 16-byte part) of each source packet. Namely, an area within the start part of 128 bits (or 16-byte part) of the start source packet of the encryption processing unit (1 AU) shown in FIG. 19 is the area to be set as the seed 2 area. If a source packet storing the divided data of program map table PMT is arranged as this start source packet of encryption processing unit (1 AU), the start 128-bit part of this source packet is possibly set as seed 2. In this case, this data area is passed from the content authoring entity 330 to each disc manufacturer entity in the form of plaintext.

As shown in FIG. 20(b), the start packet (No. 1) always stores 8-bit table ID specified as the start data of program map table PMT, 76-bit control information and identification information, and 12-bit program information length. The packets No. 2 and following packets each store the data subsequent to the halfway data of program information.

Each of the No. 2 and subsequent packets is attached at its head a total of 8 bytes=96 bits of 4-byte TS packet header and 4-byte source packet header. If this 8-byte data is immediately followed by authoring studio code (ASC) and disc manufacturer code (DMC), a portion which overlaps the seed 2 area of the start 128 bits (or 16 bytes) of source packet occurs, which is passed from the content authoring entity 330 to each disc manufacturer entity in the form of plaintext.

However, since the start packet (No. 1) always stores 8-bit table ID specified as the start data of program map table PMT, 76-bit control information and identification information, and 12-bit program information length, a total of 21 bytes (=168 bits) of 4 bytes of source packet header, 4 bytes of TS packet header, 1 byte of pointer, and 12 bytes (96 bits) of start data of program map table PMT) are set as shown in FIG. 20(e).

These 21 bytes (=168 bits) are longer than the maximum bit length 16 bytes (128 bits) of seed 2. Therefore, the program information area stored in the payload of the start packet (No. 1) will not overlap the seed 2 setting area.

Consequently, storing authoring studio code (ASC) and disc manufacturer code (DMC) into the data area (within 183 bytes from the start of PMT) stored in the start packet in the program information area in program map table PMT puts these codes into a area that is always encrypted by block key Kb2.

To be more specific, as shown in FIG. 20(d), if the source packet storing the start data of program map table PMT is set as the start source packet of 1 AU which is encryption processing unit and the seed 2 area 541 is set, the 16-byte (or 128-bit) area which is set as the start seed 2 information area of that source packet falls within the total 21-byte (=168 bits.) area of source packet header (4 bytes), TS packet header (4 bytes), pointer (1 byte), start data 12 bytes of program map table PMT, so that the program information area included in the start packet is set as an encrypted area 542 encrypted by block key Kb2. By setting authoring studio code (ASC) and disc manufacturer code (DMC) to this encrypted area, these codes are always encrypted by block key Kb2.

The above-mentioned setting requires to control the storage locations of authoring studio code (ASC) and disc manufacturer code (DMC) in program map table PMT. Namely, the following two conditions must be satisfied:

(1) both authoring studio code (ASC) and disc manufacturer code (DMC) must always be included in the start packet; and

(2) these codes should not be included in the seed 2 area (within 128 bits) of the start part of the start packet.

To be more specific, in the present embodiment, the satisfaction of condition (1) requires to record authoring studio code (ASC) and disc manufacturer code (DMC) within 183 bytes from the beginning of program map table PMT because the payload portion of the start TS packet is 183 bytes long.

The satisfaction of condition (2) requires to prevent the storage locations of authoring studio code (ASC) and disc manufacturer code (DMC) from being set within the first 128 bits of each source packet. However, as shown in FIG. 20, condition is satisfied because there exist a total of 21 bytes, namely, 4 bytes of source packet header, TS packet header and point of 4+1=5 bytes, and text header of 12 bytes of the start of PMT in the PMT configuration specified in ISO/IEC 13818-1: 1996 (MPEG system), this area is greater than seed 2 area k of 16 bytes, and authoring studio code (ASC) and disc manufacturer code (DMC) are recorded in the subsequent program information area.

Consequently, executing the control of storage location of each code within PMT in which the codes are stored in the program information area of program map table PMT and the data area within 183 bytes from the beginning of program map table PMT prevents the storage of these codes from matching the seed 2 area, thereby preventing these codes from being passed from the content authoring entity 330 to each disc manufacturer entity in the form of plaintext.

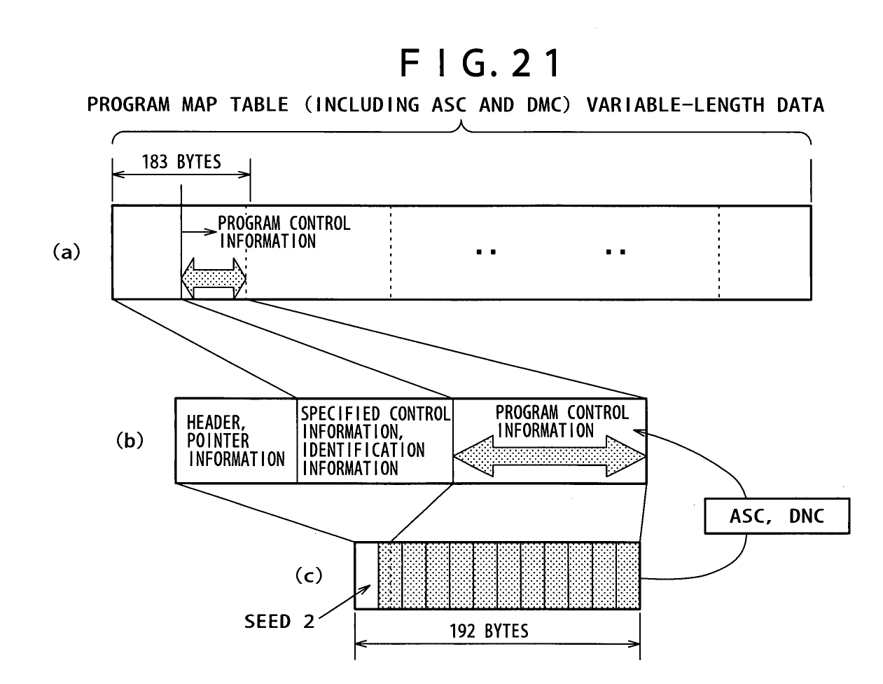

Namely, as shown in FIG. 21, the 183 bytes from the beginning of program map table PMT of (a) provide the information area which is stored as the payload of the start TS packet and the storage locations of authoring studio code (ASC) and disc manufacturer code (DMC) are set inside the program information area included in this information area.

As a result, as shown in (b) and (c), the program information area in which authoring studio code (ASC) and disc manufacturer code (DMC) are stored becomes an area that is encrypted by block key Kb2, thereby allowing these codes to be encrypted without failure, the encrypted codes being passed from the content authoring entity 330 to each disc manufacture entity.

The processing operations that the content authoring entity 330 executes in the PMT (Program Map Table) embedding block 532 shown in FIG. 17 are summarized as follows:

(1) controlling the write positions of authoring studio code (ASC) and disc manufacturer code (DMC), which are entity codes set in correspondence with the entities of the manufacturing route of information recording media to set these codes into program map table (PMT), which is a control information table;

(2) generating PMT stored packets in which two or more packets storing the control information table are stored in a divided manner; and

(3) arranging the PMT stored packets into a content stored packet sequence in a distributed manner.

In the above-mentioned entity code setting processing (1), the processing in which authoring studio code (ASC) and disc manufacturer code (DMC) are controlled such that these codes are included, without overlapping the seed 2 setting area, into the encrypted area that is encrypted by the key (block key Kb2) generated on the basis of seed 2.

It should be noted that, in the present embodiment, authoring studio code (ASC) and disc manufacturer code (DMC) are used for the identification codes; however, as described before, a configuration is also practicable in which identification information (codes) are assigned to various entities, managed by the trusted center, existing in the manufacturing and distributing processes of content recorded media for example. If an identification code is assigned to each of these entities, each code is stored in an area that is encrypted without failure by block key Kb2, as described before.

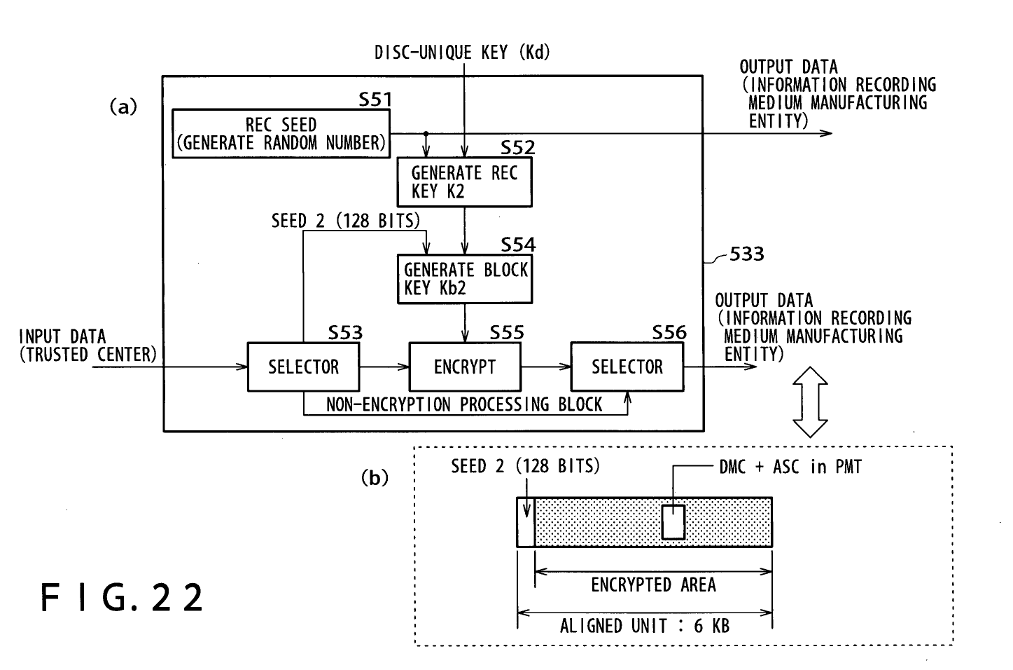

The content authoring entity 330 executes the above-mentioned processing operations through the PMT (Program Map Table) embedding block 532 shown in FIG. 17 to embed PMT including authoring studio code (ASC) and disc manufacturer code (DMC) and then executes the encryption processing through the encryption processing block 533 shown in FIG. 17. The following describes the details of the processing to be executed by the encryption processing block 533 of the content authoring entity 330, with reference to FIG. 22.

In step S51, the content authoring entity 330 generates a record seed (REC SEED) on the basis of random numbers. The record seed (REC SEED) is data to be passed to an information recording medium manufacturing entity as output data. In step S52, record key K2 is generated by use of disc-unique key Kd supplied from the trusted center 300 and by executing the encryption processing applied with the record seed (REC SEED). In step S53, block key Kb2 is generated (in step S54) on the basis of the seed information (seed 2) extracted from the content and record key K2. In step S55, the data area including the content and program map table is encrypted by use of block key Kb2. In selector step S53, seed 2 is selected and the data part on which the encryption processing of step S55 is executed is separated from the data part on which the encryption processing of step S55 is not executed. In step S56, the encrypted data and the non-encrypted data are linked again to be passed to the information recording medium manufacturing entity along with the record seed (REC SEED) as disc image data.

In the data outputted from the content authoring entity 330, the seed information (seed 2) is set as plaintext data and the other information is encrypted by block key Kb2 generated by applying seed 2 as shown in FIG. 22 (b). This encrypted data contains PMT (Program Map Table) including authoring studio code (ASC) and disc manufacturer code (DMC).

The following describes the processing to be executed by the information recording medium manufacturing entity 350 with reference to FIG. 17 again. The information recording medium manufacturing entity 350 executes encryption processing through a encryption processing block 551 on the content supplied from the information recording medium manufacturing entity 350.

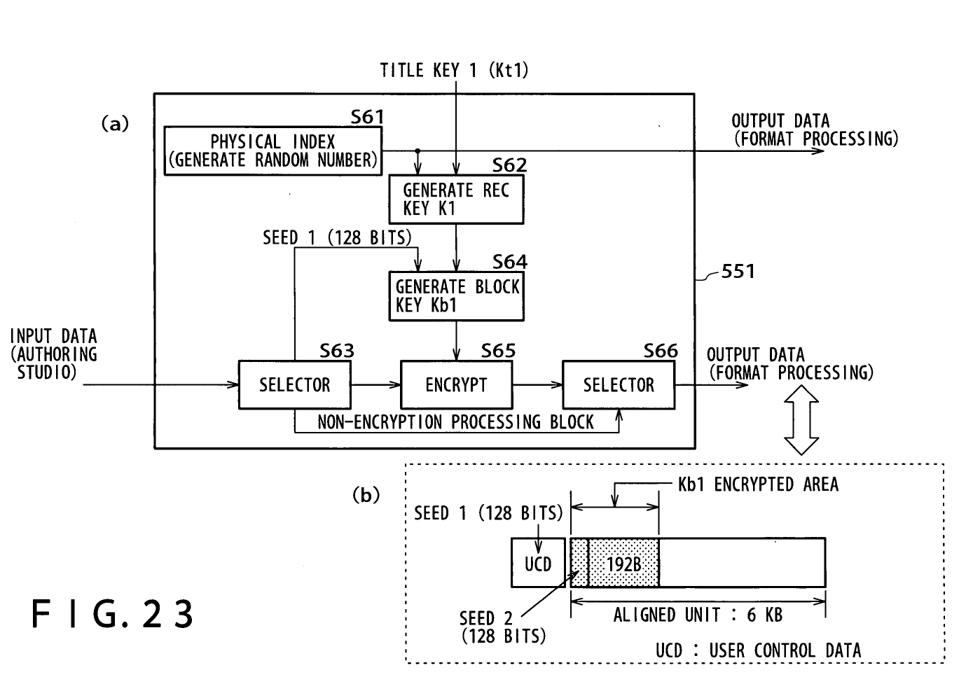

The following describes the details of the encryption processing to be executed by the encryption processing block 551 of the information recording medium manufacturing entity 350, with reference to FIG. 23.

In step S62, the information recording medium manufacturing entity 350 generates a physical index on the basis of random number. In step S62, this entity generates record key K1 by the encryption processing applied with first title key Kt1 supplied from the trusted center 300 and the physical index generated above. In step S63, this entity generates block key Kb1 (step S64) on the basis of the seed information (seed 1) selected from the content and record key K1. In step S65, this entity executes the processing of encrypting the data area that includes the seed information (seed 2) in the content on the basis of block key Kb1. In selector step S63, seed 1 is selected and the data part on which the encryption processing in step S65 is executed is separated from the data part on which the encryption processing in step S65 is not executed. In step S66, the encrypted data and non-encrypted data are linked again to provide output data.

In the data to be outputted from the encryption processing block 551 of the information recording medium manufacturing entity 350, the seed information (seed 1) is set in the control data (UCD: User Control Data) as plaintext data as shown in FIG. 23(b) and the data area including seed 2 is encrypted by block key Kb1 generated by applying seed 1.

Referring to FIG. 17 again, the description of the processing to be executed by the information recording medium manufacturing entity 350 will be continued. The output data of the encryption processing block 551 of the information recording medium manufacturing entity 350 is inputted in a format processing block 552 to execute the processing of writing EKB 512 supplied from the trusted center 300, encrypted second title key eKm(Kt2) 513, encrypted first title key eKm(Kt1) 514, eKt2(ASC) 515 which is encrypted ASC, and eKt2(DMC) 516 which is encrypted DMC to the lead-in area (refer to FIG. 1) of the disc. In this write processing, the physical index generated in step S61 shown in FIG. 23(a) is also recorded to the disc.

Further, the information recording medium (or the disc) containing the above-mentioned items of information is replicated by a replicator 553. The amount of replications is equivalent to bulk order count N set by the trusted center 300. The different disc IDs supplied by the trusted center 300 are stored in different discs.

When all of these items of information have been stored, the information recording medium 100 is distributed on the market. The content recorded on the purchased information recording medium 100 is reproduced on the information processing device of the user on the basis of the above-mentioned decryption processing and reproduction control processing. The information recording medium 100 stores the various items of information described with reference to FIG. 1 and is reproduced on the information processing device of the user on the basis of the decryption and control processing described with reference to FIGS. 9 through 15.

[Processing Configuration Without Using Disc ID]

In the above-mentioned embodiment, different disc IDs are set to different information recording media, the user device gets the disc ID from each information recording medium, verification is performed on the disc ID, disc-unique key Kd is generated by applying disc-unique seed S, which is a component of the disc ID (steps S15 shown in FIG. 10), and the content is decrypted by applying the generated disc-unique key Kd.

However, the processing of recording different IDs to different information recording media takes much time, so that it is sometimes desired to omit this processing. The following describes an example of the processing that does not use different disc IDs for different information recording media.

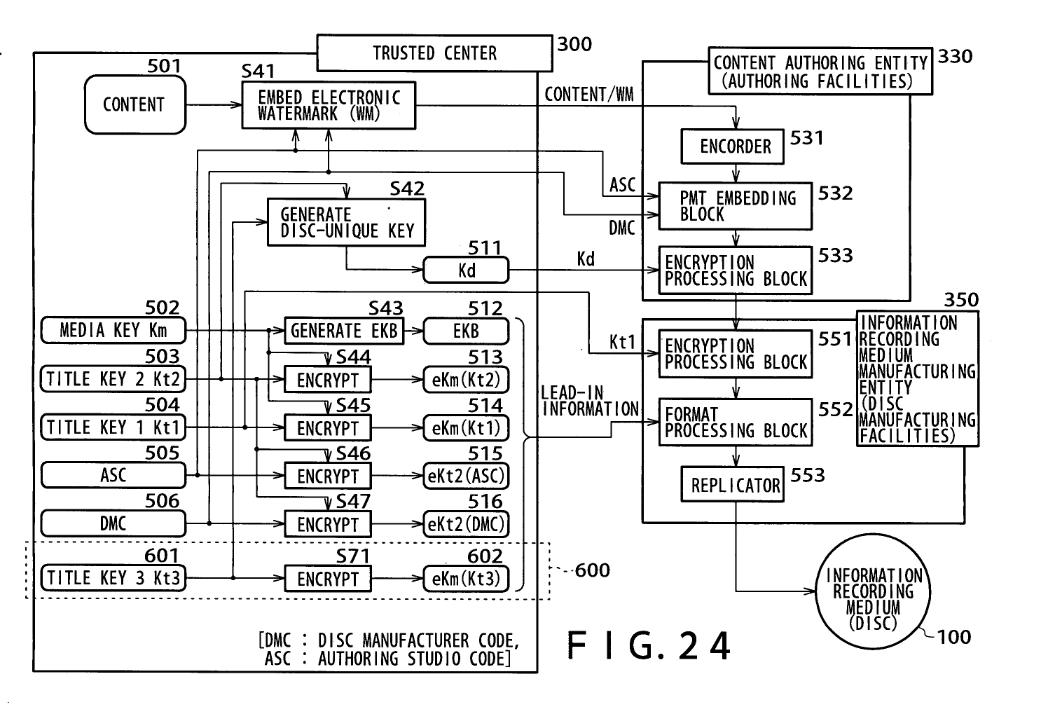

FIG. 24 shows an example of the processing that does not use the disc IDs that are used by the trusted center 300, the content authoring entity 330, and information recording medium manufacturing entity 350 in the foregoing embodiment.

Referring to FIG. 24, an area 600 enclosed by dashed lines is different from the configuration in which disc IDs are used, described before with reference to FIG. 17. It should be noted that the processing and configuration associated with the disc IDs described with reference to FIG. 17 are not shown in FIG. 24.

A trusted center 300 holds a content 501 supplied by its owner, sets media key Km 502, second title key Kt2 503, first title key Kt1 504, authoring studio code (ASC) 505, disc manufacturer code (DMC) 506 to the content to be stored in each information recording medium to be manufactured or to the medium itself, and sets third title key Kt3 601 to content to be stored in each information recording medium to be manufactured or to the medium itself.

In this another embodiment, the disc-unique seed S 507 and the number of information recording media permitted for manufacture, namely, bulk order disc count N 508, are omitted from the configuration.

In step S41, the trusted center 300 embeds authoring studio code (ASC) 505 and disc manufacturer code (DMC) 506 into the content 501 supplied by its owner, as electronic watermark.

The trusted center 300 provides the content embedded with the electronic watermark, authoring studio code (ASC) 505, disc manufacturer code (DMC) 506, and disc-unique key Kd 511 to the content authoring entity 330.

In step S43, the trusted center 300 generates EKB 512, which is a cryptographic key block configured to be obtainable only in the device key of the user device having media key Km 502 as a license, which is the right of content reproduction.

In step S44, the trusted center 300 encrypts second title key Kt2 503 on the basis of media key Km 502 to generate encrypted second title key eKm(Kt2) 513. In step S45, the trusted center 300 encrypts first title key Kt1 504 on the basis of media key Km 502 to generate encrypted first title key eKm(Kt1) 514.

Further, in step S46, the trusted center 300 encrypts authoring studio code (ASC) 505 by second title key Kt2 503 to generate eKt2(ASC) 515, which is encrypted ASC. In step S47, the trusted center 300 encrypts disc manufacturer code (DMC) 506 by second title key Kt2 503 to generate eKt2(DMC) 561, which is encrypted DMC.

In step S71, the trusted center 300 encrypts third title key Kt3 601 on the basis of media key Km 502 to generate encrypted third title key eKm(Kt3) 602.

EKB 512, encrypted second title key eKm(Kt2) 513, encrypted first title key eKm(Kt1) 514, eKt2(ASC) 515, eKt2(DMC) 516, and encrypted third title key eKm(Kt3) 602 are provided from the trusted center 300 to the information recording medium manufacturing entity 350.

The processing by the content authoring entity 330 and the processing by the information recording medium manufacturing entity 350 are basically the same as described before with reference to FIGS. 17 through 23. However, a format processing block 552 of the information recording medium manufacturing entity 350 executes the processing of writing to the lead-in area of each information recording medium and a replicator 553 of the information recording medium manufacturing entity 350 does not execute the processing of writing of the disc ID for each disc.

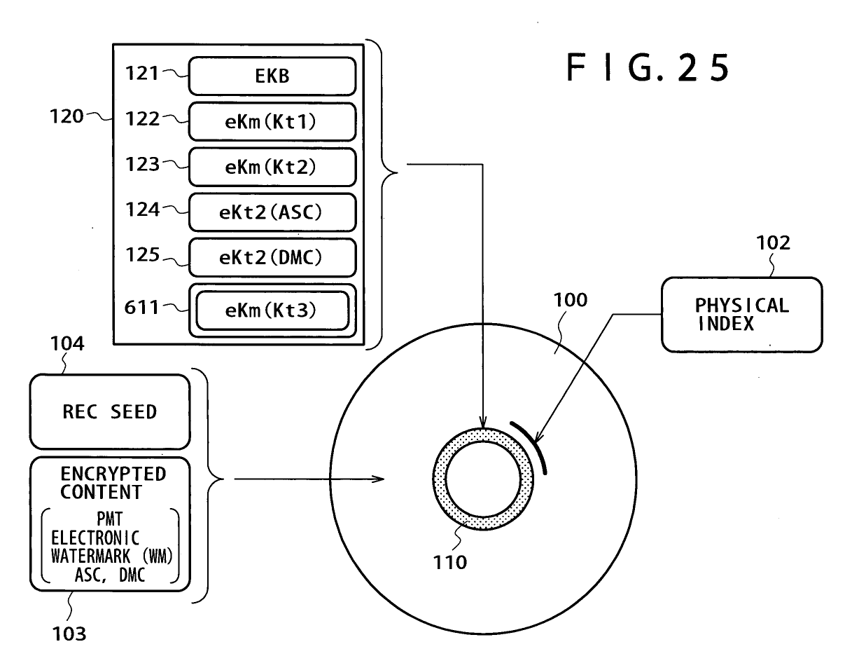

An information recording medium 100 manufactured as a result of the above-mentioned processing stores the data as shown in FIG. 25.

As shown in FIG. 25, stores a physical index 102, encrypted content 103, a record seed (REC SEED) 104, and cryptographic key information 120. The cryptographic key information 120 is stored in the lead-in area 110 that is different from the content storage area of the information recording medium 100 and can be read by a special program.

The cryptographic key information 120 includes encrypted third title key eKm(Kt3). The differences from the configuration shown in FIG. 1 are that no disc ID is stored and encrypted third title key eKm(Kt3) 611 is added to the cryptographic key information 120.

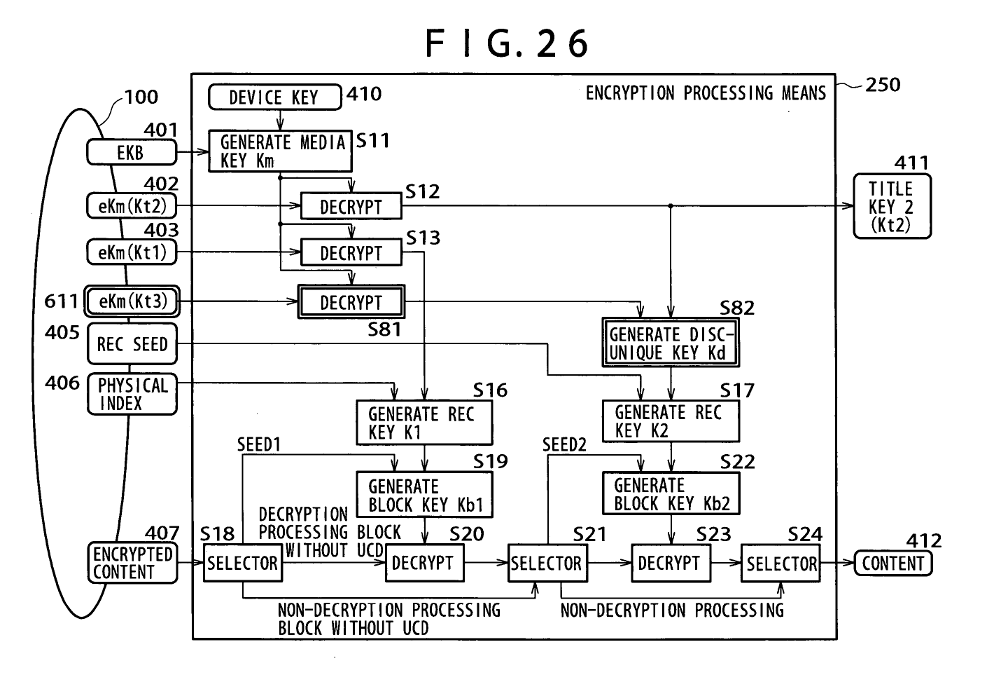

The following describes the content decryption processing to be executed by a encryption processing means of an information processing device (or the user device) that reproduces the above-mentioned information recording medium, with reference to FIG. 26.

The processing shown in FIG. 26 defers from the processing of reproducing the information recording medium having a disc ID described before with reference to FIG. 10 in that the information recording medium 100 has encrypted third title key eKm(Kt3) 611 and there are the processing of generating disc-unique key Kd of step S82 and the processing of decrypting encrypted third title key eKm(Kt3) 611 of step S81.

In the present embodiment, disc-unique seed S (refer to step S14 shown in FIG. 10) obtained from the disc ID is not applied to the processing of generating disc-unique key Kd.

In the present embodiment, in step S81, encrypted third title key eKm(Kt3) 611 is decrypted by use of media key Km to get third title key Kt3. In step S82, encryption processing is executed by use of obtained third title key Kt3 and second title key Kt2 obtained by the decryption processing of step S12, thereby generating disc-unique key Kd.

The subsequent processing is the same as the processing described before with reference to FIG. 10. In the present embodiment, of which configuration uses no disc ID, the processing of recording different IDs to different information recording media is not required, thereby mitigating the processing load of each information recording medium manufacturing entity in the bulk production of discs, for example.

In the present embodiment, the content stored in an information recording medium is also encrypted by block keys Kb1 and Kb2 generated by seed information (seed 1) and seed information (seed 2), and seed information (seed 2) is encrypted by the key generated by use of seed information (seed 1), namely, block key Kb1, before being stored, so that their direct reading from the information recording medium is impossible, thereby enhancing the robustness against the analysis of seed information (seed 2), the analysis of block key Kb2 generated by use of seed information (seed 2), and the analysis of the encryption algorithm in which user data is encrypted by block key Kb2.

Further, authoring studio code (ASC) and disc manufacturer code (DMC) are set to the area that is encrypted without failure by block key Kb2 generated by applying seed information (seed 2), these codes are then encrypted at the content authoring entity 330, and the encrypted codes are passed to the information recording medium manufacturing entity 350, thereby preventing the code information from being leaked outside.

In addition, the reproduction processing is executed only when the detection and matching of authoring studio code (ASC) and disc manufacturer code (DMC) are successfully made, so that any attempt to reproduce any content that has no authorized code or no electronic watermark is defeated, thereby allowing the reproduction of only the content stored recording media manufactured on the basis of authorized manufacturing routes. In case the manufacturing and distributing of unauthorized replications should happen, this configuration also allows the easy tracing of information leakage routes by the detection of authoring studio code (ASC) and disc manufacturer code (DMC).

[Exemplary Configuration of Information Processing Device and Other Entities]

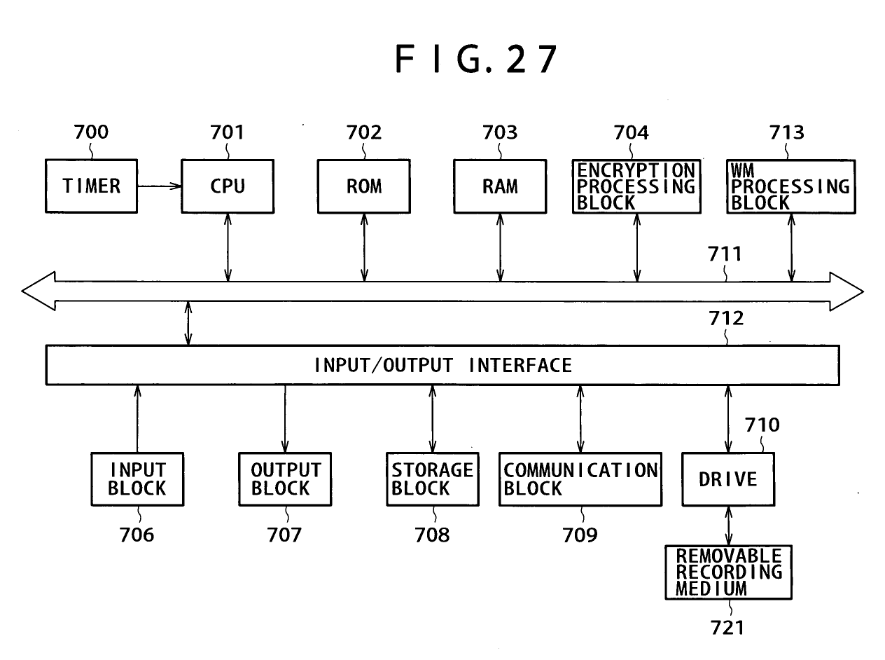

The following describes, with reference to FIG. 27, exemplary configuration of the information processing device as a user device, the trusted center, the content authoring entity, the information recording medium manufacturing entity, and the information processing device applied for each entity to execute encryption and data generation processing described in the above-mentioned embodiments of the invention. For the information processing device as a user device, the trusted center, the content authoring entity, the information recording medium manufacturing entity, and the information processing device applied for each entity to execute encryption processing and data generation processing described in the above-mentioned embodiments of the invention, general-purpose information processing devices, such as PCs and information processing servers are available. The following describes, with reference to FIG. 27, an exemplary configuration of an information processing device for each of the above-mentioned entities to execute encryption processing and data generation processing.

A CPU (Central Processing Unit) 701 executes various processing operations as directed by various programs stored in a ROM (Read Only Memory) 702 or programs stored in a storage block 708 and loaded into a RAM (Random Access Memory) 703. A timer 700 executes clocking and supplies clock information to the CPU 701.

The ROM (Read Only Memory) 702 stores parameters for computation and fixed data for use by programs. The RAM (Random Access Memory) 703 stores programs for use in the execution of the CPU 701 and parameters that change from time to time in the execution of the CPU 701. These components are interconnected by a bus 711.

A encryption processing block 704 executes various kinds of encryption processing described above, the encryption processing applying the AES encryption algorithm for example. A WM processing block 713 executes the processing based on information hiding technologies, such as embedding data into video signal as invisible information by use of the spread spectrum technology or embedding data into audio signal as unrecognizable information, for example.

An input/output interface 712 is connected with an input block 706 based on keyboard and mouse for example, an output block 707 based on display like CRT or LCD and speaker, the storage block 708 based on hard disc drive, and a communication block 709. The communication block 709 communicates with the above-mentioned entities for example by data transmission/reception over a communication network such as the Internet.

While preferred embodiments of the present invention have been described using specific terms, such description is for illustrative purpose only, and it is to be understood that changes and variations may be made without departing from the spirit or scope of the following claims.

The above-mentioned sequence of processing operations may be executed by software or hardware or a combination of both. When the above-mentioned sequence of processing operations is executed by software, the programs constituting the software are installed in a memory of a computer which is built in dedicated hardware equipment, or installed into a general-purpose computer for example in which various programs may be installed for the execution of various functions.

For example, programs may be stored in the hard disc drive or the ROM (Read Only Memory) functioning as recording media in advance. Alternatively, programs can be stored (or recorded) temporarily or permanently in removable recording media, such as flexible disc, CD-ROM (Compact Disc Read Only Memory), MO (Magneto-Optical) disc, DVD (Digital Versatile Disc), magnetic disc, and semiconductor memory. These removable recording media can be provided in the form of so-called package software.

It should be noted that, instead of installing from any of the above-mentioned removable recording media into the computer, programs can be downloaded from download sites onto the computer in a wireless manner or via a network such as LAN (Local Area Network) or the Internet in a wired manner. Receiving the programs supplied in any of the above-mentioned methods, the computer can install the received programs into its incorporated recording media such as the hard disc drive for example.

It should also be noted that the above-mentioned various processing operations herein can be executed not only in a time-dependent manner in accordance with their description but also in a parallel manner or an individual manner in accordance with the performance of the device that executes these processing operations. Term “system” as used herein denotes a logical aggregation of plural devices and is not restricted to a configuration in which all its components are accommodated in a single housing.

### INDUSTRIAL APPLICABILITY

As described and according to the invention, the entity codes such as authoring studio code (ASC) and the disc manufacturer code (DMC) can be encrypted without failure and stored in information recording media to prevent these entity codes from being leaked outside. Therefore, the novel configuration can prevent the manufacturing of the recording media in which stored an illegally obtained copy of content made by use of these entity codes that are illegally obtained by masquerading entities. To be more specific, the data setting locations in program map table (PMT) is controlled such that these entity codes will not overlap the seed area that provides key generating information, so that, if the packet storing the program map table storing authoring studio code (ASC) and disc manufacturer code (DMC) is set to an arbitrary position in a content packet sequence, these entity codes will not overlap the seed area that is non-encrypted data, thereby preventing these entity codes from being leaked outside.

Further, in the novel configuration, authoring studio code (ASC) and disc manufacturer code (DMC) are stored in each information recording medium along with encrypted content and the encrypted content can be reproduced only when the detection and matching of these entity codes are successfully executed, so that any attempt to reproduce content stored in any recording medium having the illegally obtained codes or any information recording medium that stores none of these entity codes is defeated, thereby allowing the reproduction of only the content stored in the recording media that have been manufactured on the basis of authorized manufacturing routes. In case the manufacturing and distributing of unauthorized replications should happen, this configuration also allows the easy tracing of information leakage routes by the detection of authoring studio code (ASC) and disc manufacturer code (DMC).

In addition, in the novel configuration, the code information of each entity is stored in each information recording medium, so that only the content authoring entity and information recording medium manufacturing entity that are managed by the trusted center are allowed to author content and manufacture the information recording media storing the authored content, thereby making it practicable, in case of the illegal replication of the information recording media, to trace information leakage routes on the basis of the detection of these entity codes.

1. An information recording medium storing encrypted content, having a configuration in which
content and an entity code set for each entity in a manufacturing route of said information recording medium, and data included in a certain encryption processing unit is encrypted by a key generated on the basis of a seed providing encryption processing key generating information set for each said encryption processing unit and
said entity code is stored in an encrypted area which is encrypted by said key generated on the basis of said seed, said encrypted area not overlapping an area to which said seed is set.

2. The information recording medium according to claim 1, wherein said encryption processing unit is set as a collective data area of a plurality of packets and said seed is set as data having the predetermined number of bits from start data of a start packet of said encryption processing unit and
said entity code is stored as a payload of each of said plurality of packets and stored in a data area not overlapping an area of bits constituting said seed.

3. The information recording medium according to claim 1, wherein said entity code is stored in a program map table (PMT) specified by the MPEG standard and said entity code provides data constituting a start packet of a plurality of divided packets storing said program map table (PMT) in a program information area of said program map table (PMT).

4. The information recording medium according to claim 3, wherein said start packet of said plurality of divided packets is a transport stream packet having a payload of 183 bytes and said entity code is stored as data within 183 bytes from start data of said program map table (PMT) in said program information area of said program map table (PMT).

5. The information recording medium according to claim 1, wherein said entity code is stored in a program map table (PMT) specified by the MPEG standard,
said program map table (PMT) is stored as a payload of each of a plurality of transport stream packets in a divided manner, and each of said plurality of transport stream packet is attached with timestamp information to be stored in said information recording medium as a source packet in a distributed manner.

6. The information recording medium according to claim 1, wherein said information recording medium includes a first seed, which is key generating information set for each said encryption processing unit,
an encrypted second seed, which is key generating information encrypted on the basis of a first block key Kb1 generated by said first seed, and
encrypted content and an encrypted entity code encrypted on the basis of a second block key Kb2 generated on the basis of said second seed.

7. The information recording medium according to claim 1, wherein said entity code includes an authoring studio code (ASC) and a disc manufacturer code (DMC).

8. A data processing method for generating data to be written to an information recording medium, comprising:
an entity code setting step in which a position at which an entity code set for an entity in a manufacturing route of said information recording medium is set is controlled to set said entity code in a control information table;
a table information stored packet generating step in which a plurality of packets in which said control information table is stored in a divided manner are generated;
a step in which said plurality of table information stored packets are arranged in a content stored packet sequence in a distributed manner; and
a step in which data included in a certain encryption processing unit is encrypted by use of a key generated on the basis of a seed which is encryption processing key generating information set for each said encryption processing unit;
wherein said entity code setting step includes a step in which control is executed such that said entity code is included in an encrypted area encrypted by a key generated on the basis of said seed without overlapping an area to which said seed is set.

9. The data processing method according to claim 8, wherein said encryption processing unit is a collective data area of a plurality of packets, said seed is data having the predetermined number of bits from start data of a start packet of said encryption processing unit, and
said entity code setting step includes a step in which said entity code is set to a data area which does not overlap an area of bits constituting said seed.

10. The data processing method according to claim 8, wherein, in said entity code setting step, said entity code is set in a program information area of said program map table (PMT) specified by the MPEG standard and to a position of data constituting a start packet of a plurality of divided packets storing said program map table (PMT).

11. The information processing method according to claim 10, wherein said start packet of said plurality of divided packets is a transport stream packet having a payload of 183 bytes and,
in said entity code setting step, said entity code is set as data said program information area of said program map table (PMT) and within 183 bytes from start data of said program map table (PMT).

12. A computer program for executing the processing of generating data to be written to an information recording medium, comprising:
an entity code setting step in which a position at which an entity code set for an entity in a manufacturing route of said information recording medium is set is controlled to set said entity code in a control information table;
a table information stored packet generating step in which a plurality of packets in which said control information table is stored in a divided manner are generated;
a step in which said plurality of table information stored packets are arranged in a content stored packet sequence in a distributed manner; and
a step in which data included in a certain encryption processing unit is encrypted by use of a key generated on the basis of a seed which is encryption processing key generating information set for each said encryption processing unit;
wherein said entity code setting step includes a step in which control is executed such that said entity code is included in an encrypted area encrypted by a key generated on the basis of said seed without overlapping an area to which said seed is set.
